(19) United States
(12) Patent Application Publication
(10) Pub. No.: US 2009/0075074 A1
(43) Pub. Date: Mar. 19, 2009

(54) OPTICAL LAYERED BODY, METHOD OF PRODUCING THE SAME, POLARIZER, AND IMAGE DISPLAY DEVICE

(75) Inventors: Tomoyuki Horio, Tokyo (JP); Yukimitsu Iwata, Tokyo (JP); Takashi Kodama, Tokyo (JP); Mariko Hayashi, Tokyo (JP); Kenji Ueno, Tokyo (JP); Atsuhiro Kobayashi, Tokyo (JP); Yoshimasa Ogawa, Tokyo (JP); Yuichi Takaura, Tokyo (JP); Junya Eguchi, Tokyo (JP); Kiyotaka Matsui, Tokyo (JP)

Correspondence Address: CONNOLLY BOVE LODGE & HUTZ LLP, 1875 EYE STREET, N.W., SUITE 1100, WASHINGTON, DC, 20006, US

(73) Assignee: Dai Nippon Printing Co., Ltd., Tokyo (JP)

(21) Appl. No.: 12/209,366

(22) Filed: Sep. 12, 2008

(30) Foreign Application Priority Data
Sep. 12, 2007 (JP) 2007-237210
Sep. 12, 2007 (JP) 2007-237211

(51) Int. Cl. B32B 27/32; G02B 1/10; B05D 5/06

(52) U.S. Cl. 428/341; 427/163.1; 427/162

(57) ABSTRACT

It is an object of the present invention to provide an optical layered body which is produced at low cost and is superior in all an antistatic property, hardness and optical properties such as haze and a total light transmittance.

An optical layered body comprising a light-transmitting substrate and a hard coat layer formed on the light-transmitting substrate,
wherein the hard coat layer is a resin layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent; and
a content of the quaternary ammonium salt in the hard coat layer is 0.5 to 18% by weight.

### TECHNICAL FIELD

The present invention relates to an optical layered body, a method of producing the same, a polarizer, and an image display device.

### BACKGROUND OF THE INVENTION

In image display devices such as cathode ray tube (CRT) display devices, liquid crystal displays (LCD), plasma displays (PDP), electroluminescence displays (ELD) and field emission displays (FED), optical layered bodies including a layer having various functions such as an antireflection property, hardness and an antistatic property are generally provided at the outermost surfaces of the displays.

As one of such the functional layers of the optical layered bodies, an antistatic layer for providing an antistatic property is known. This antistatic layer is formed by adding an antistatic agent such as conductive ultrafine particles of metal oxide e.g. antimony-doped tin oxide (ATO), tin-doped indium oxide (ITO) or the like, organic conductive polymers and quaternary ammonium salt conductive materials (Japanese Kokai Publication Hei-5-339306, Japanese Kokai Publication Hei-11-42729, Japanese Kokai Publication 2002-3751, Japanese Kokai Publication 2004-338379, and Japanese Kokai Publication 2005-154749). Here, the quaternary ammonium salt is often used as an antistatic agent of an application type, and for example, in Japanese Kokai Publication 2000-129245, a cationic copolymer having quaternary ammonium salt group, which is superior in solubility in a hydrophobic solvent or a resin, is disclosed.

When these antistatic agents are used, it has been performed to impart a desired function by forming a thin film layer of about 1 μm in thickness containing the antistatic agent in order to achieve a desired antistatic property and optical properties (low haze, high total light transmittance) simultaneously.

On the other hand, as another functional layer, a hard coat layer for providing a certain level of strength as an optical layered body is known (Japanese Kokai Publication 2006-126808). The hard coat layer is generally a layer exhibiting the hardness of class “H” or higher in a scratch hardness test by pencil method specified by JIS K 5600-5-4 (1999) and a layer having a film thickness of about 0.1 to 100 μm.

However, these layers had problems that since these layers were separately formed as each layer having each function, for example when an antistatic layer, a hard coat layer, and a low refractive index layer are formed in this order on a substrate, strength and haze of the optical layered body are good (that is, the optical layered body has low haze and a high and good total light transmittance) but an antistatic property becomes insufficient. On the other hand, when a hard coat layer, an antistatic layer, and a low refractive index layer are formed in this order on a substrate, the antistatic property and the haze are good but the strength is insufficient. Therefore, an optical layered body which is superior in all an antistatic property, hardness and optical properties such as haze and a total light transmittance has been desired.

### SUMMARY OF THE INVENTION

In view of the above state of the art, it is an object of the present invention to provide an optical layered body which is produced at low cost and is superior in all an antistatic property, hardness and optical properties such as haze and a total light transmittance.

The present invention relates to an optical layered body comprising a light-transmitting substrate and a hard coat layer formed on the light-transmitting substrate, wherein the hard coat layer is a resin layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent; and a content of the quaternary ammonium salt in the hard coat layer is 0.5 to 180 by weight.

The present invention further relates to an optical layered body comprising a light-transmitting substrate, an antistatic layer and a hard coat layer, wherein the hard coat layer is a resin layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent; and a content of the quaternary ammonium salt in the hard coat layer is 0.1 to 100 by weight.

Preferably, the quaternary ammonium salt is a compound having a photoreactive unsaturated bond.

Preferably, the hard coat layer-forming composition further contains a hexa- or morefunctional (meth)acrylate compound having a weight average molecular weight of 1000 or more.

Preferably, the hexa- or morefunctional (meth)acrylate compound having a weight average molecular weight of 1000 or more is a urethane (meth)acrylate compound.

Preferably, a mixing ratio of the hexa- or morefunctional urethane (meth)acrylate compound having a weight average molecular weight of 1000 or more to the tri- or morefunctional (meth)acrylate compound having a weight average molecular weight of 700 or less is 5/95 to 90/10 in terms of solid weight ratio.

Preferably, the light-transmitting substrate is made from triacetyl cellulose.

Preferably, the permeable solvent is at least one selected from the group consisting of methyl acetate, ethyl acetate, butyl acetate, methyl ethyl ketone, methyl isobutyl ketone and cyclohexanone.

Preferably, the optical layered body of the present invention further comprises a low refractive index layer.

Preferably, the optical layered body further comprises an antifouling layer.

The present invention also relates to a method of producing an optical layered body comprising the step of applying a hard coat layer-forming composition onto a light-transmitting substrate to form a hard coat layer, wherein the hard coat layer-forming composition contains a quaternary ammonium salt having a weight average molecular weight of 1000 to 50000, a tri- or morefunctional (meth)acrylate compound having a weight average molecular weight of 700 or less, and a permeable solvent.

The present invention also relates to a method of producing an optical layered body comprising the steps of applying an antistatic layer-forming composition onto a light-transmitting substrate to form an antistatic layer, and applying a hard coat layer-forming composition onto the antistatic layer to form a hard coat layer, wherein the hard coat layer-forming composition contains a quaternary ammonium salt having a weight average molecular weight of 1000 to 50000, a tri- or morefunctional (meth)acrylate compound having a weight average molecular weight of 700 or less, and a permeable solvent.

The present invention also relates to a method of producing an optical layered body comprising the steps of applying a hard coat layer-forming composition onto a light-transmitting substrate to form a hard coat layer, and applying an antistatic layer-forming composition onto the hard coat layer to form an antistatic layer, wherein the hard coat layer-forming composition contains a quaternary ammonium salt having a weight average molecular weight of 1000 to 50000, a tri- or morefunctional (meth)acrylate compound having a weight average molecular weight of 700 or less, and a permeable solvent.

In addition, the present invention relates to a polarizer comprising a polarizing element, wherein the polarizer comprises the above-mentioned optical layered body on the surface of the polarizing element.

In addition, the present invention relates to an image display device comprising the above-mentioned optical layered body or the above-mentioned polarizer at the outermost surface.

### DETAILED DESCRIPTION OF THE INVENTION

Hereinafter, the present invention will be described in detail.

The first present invention pertains to an optical layered body including a light-transmitting substrate and a hard coat layer formed on the light-transmitting substrate, wherein the hard coat layer is a resin layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent, and wherein a content of the quaternary ammonium salt in the hard coat layer is 0.5 to 180 by weight. Therefore, an optical layered body which is superior in all an antistatic property, hardness and optical properties by only one layer can be formed.

That is, it is possible to efficiently impart antistatic performance to the optical layered body without having an effect on a hard-coating property by using an antistatic agent composed of a resin component in the hard coat layer.

Furthermore, by using a low molecular weight (meth)acrylate compound as a resin together with the permeable solvent, the low molecular weight (meth)acrylate compound is penetrated into the substrate, and thereby the hard coat layer, in which the antistatic agent is biased in the vicinity of the surface to some extent, can be formed in one coating. Therefore, it is possible to efficiently impart antistatic performance.

The optical layered body of the first present invention includes the hard coat layer formed from a hard coat layer-forming composition containing specific quaternary ammonium salt, (meth)acrylate having a specific molecular weight and the specific number of functional groups, and the permeable solvent.

The hard coat layer in the optical layered body of the first present invention contains quaternary ammonium salt having a molecular weight in the specific range as an antistatic agent.

Conventionally, in order to provide the antistatic property and the hard-coating property, the antistatic layer and the hard coat layer were formed as a separate layer, respectively. Therefore, it was difficult to achieve simultaneously an excellent antistatic property and an excellent hard-coating property by this layer constitution in the optical layered body.

Then, in the present invention, it becomes possible to achieve desired effects without causing problems described above by forming an antistatic hard coat layer having the antistatic property and the hard-coating property in one layer.

Here, as a method of forming the antistatic hard coat layer, a method of adding an antistatic agent to the hard coat layer-forming composition to form the antistatic hard coat layer is conceivable, but when a publicly known antistatic agent is added, the antistatic agent exists throughout the hard coat layer, and therefore, an amount of the antistatic agent to be added needed to be increased in order to improve antistatic performance (surface resistivity) and attain a satisfactory optical layered body. However, there was a problem that an increase in the amount of the antistatic agent to be added causes a reduction in hardness, an increase in haze and a reduction in a light transmittance. In the present invention, by using quaternary ammonium salt having a specific molecular weight as an antistatic agent, a specific binder resin and a specific solvent, it was possible for the first time to attain an optical layered body which has good antistatic performance (surface resistivity) in a smaller additive amount than that in employing conventional conductive ultrafine particles or conductive organic polymeric materials. Further, this optical layered body does not cause a reduction in hardness, an increase in haze and a reduction in a light transmittance.

Since the hard coat layer of the optical layered body of the first present invention is formed from a hard coat layer-forming composition containing (meth)acrylate having a specific molecular weight and the specific number of functional groups, and the permeable solvent, interlaminar adhesion between the hard coat layer and the substrate is good and interference fringes are not generated at an interface between layers.

In accordance with the present invention, since a resin layer having simultaneously the good antistatic property, the good hard-coating property and the good optical properties can be formed by one layer, a process step of the optical layered body can be simplified and a production cost can also be reduced.

The optical layered body of the first present invention has the hard coat layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent.

The quaternary ammonium salt has a weight average molecular weight of 1000 to 50000. If the weight average molecular weight is less than 1000, the quaternary ammonium salt itself permeates into the substrate and does not exists at the surface of a hard coat with efficiency, and therefore, antistatic performance (particularly surface resistivity) becomes unsatisfactory. If the weight average molecular weight is more than 50000, viscosity of the hard coat layer-forming composition is high and a coating property is deteriorated.

In addition, the weight average molecular weight of the quaternary ammonium salt is determined on the polystyrene equivalent basis by a gel permeation chromatography (GPC) method. As a solvent of a GPC mobile phase, tetrahydrofuran or chloroform may be employed. As a measuring column, a combination of commercially available columns for tetrahydrofuran or for chloroform may be used. Examples of the commercially available columns include Shodex GPC KF-801, GPC KF-802, GPC KF-803, GPC KF-804, GPC KF-805 and GPC KF-800D (every, trade name, produced by Showa Denko K.K.). As a detector, an RI (Refractive Index) detector and a UV detector may be used. The weight average molecular weight can be appropriately measured with a GPC system such as Shodex GPC-101 (manufactured by Showa Denko K.K.) using such the solvents, columns and detector.

The quaternary ammonium salt is preferably a compound having a photoreactive unsaturated bond. By having the photoreactive unsaturated bond, not only the hard coat layer can become high hardness, but also the adhesion between the hard coat layer and other layers provided on the hard coat layer can be improved compared with the case where the quaternary ammonium salt does not have the photoreactive unsaturated bond. Examples of the compound having a photoreactive unsaturated bond include compounds having a (meth)acrylate group.

Examples of commercialized products of the quaternary ammonium salt having a weight average molecular weight of 1000 to 50000 include H6100 (produced by Mitsubishi Chemical Corp.), Uniresin AS-10/M, Uniresin AS-12/M, Uniresin AS-15/M and Uniresin ASH26 (all produced by Shin-Nakamura Chemical Co., Ltd.), and the like.

The content of the quaternary ammonium salt in the hard coat layer is 0.5 to 180 by weight. If the content of the quaternary ammonium salt is less than 0.5% by weight, antistatic performance is not exerted. If the content is more than 180 by weight, hardness of the hard coat layer is reduced, and production cost becomes high. A lower limit and an upper limit of the content of the quaternary ammonium salt are preferably 2.0% by weight and 130 by weight, respectively, and more preferably 5.0% by weight and 110 by weight, respectively.

The hard coat layer-forming composition contains a tri- or morefunctional (meth)acrylate compound as a binder resin. In the present specification, the term “(meth)acrylate” includes “acrylae” and “methacrylate”. Further, in the present invention, The term “resin” means all of a monomer, an oligomer and a prepolymer, having reactivity.

Examples of the tri- or morefunctional (meth)acrylate compound include trimethylolpropane tri(meth)acrylate, pentaerythritol tri(meth)acrylate, pentaerythritol tetra(meth)acrylate, dipentaerythritol hexa(meth)acrylate, dipentaerythritol tetra(meth)acrylate, isocyanuric acid modified tri(meth)acrylate, and the like. These (meth)acrylates may be one of which a part of a molecular structure is modified, and a (meth)acrylate compound modified with ethylene oxide, propylene oxide, caprolactone, isocyanuric acid, alkyl, cyclic alkyl, aromatic, or bisphenol can also be used.

Further, the (meth)acrylate compound may be oligomers such as epoxy (meth)acrylate, urethane (meth)acrylate, polyester (meth)acrylate, polybutadiene (meth)acrylate, and silicon (meth)acrylate.

These (meth)acrylate compounds may be used in combination of two or more species.

The (meth)acrylate compound has a weight average molecular weight of 700 or less. If the weight average molecular weight of the (meth)acrylate compound is more than 700, not only adhesion to the substrate may be deteriorated, but also interference fringes may not vanish. The weight average molecular weight is more preferably at least 280 and at most 600.

The weight average molecular weight of the (meth)acrylate compound is determined on the polystyrene equivalent basis by a gel permeation chromatography (GPC) method. As a solvent of a GPC mobile phase, tetrahydrofuran or chloroform may be employed. As a measuring column, a combination of commercially available columns for tetrahydrofuran or for chloroform may be used. Examples of the commercially available columns include Shodex GPC KF-801, and GPC KF-800D (every, trade name, produced by Showa Denko K.K.). As a detector, an RI (Refractive Index) detector and a UV detector may be used. The weight average molecular weight can be appropriately measured with a GPC system such as Shodex GPC-101 (manufactured by Showa Denko K.K.) using such the solvents, columns and detector.

The hard coat layer-forming composition preferably further contains a hexa- or morefunctional (meth)acrylate compound as a binder resin. By containing the hexa- or morefunctional (meth)acrylate compound, it is possible to provide a desired hard-coating property as described later and to form an optical layered body having an excellent scratch hardness (pencil method). The hexa- or morefunctional (meth)acrylate compound is more preferably deca- or morefunctional.

Examples of the hexa- or morefunctional (meth)acrylate compound include urethane, ether, epoxy, ester, and silicon (meth)acrylate compounds (monomers, oligomers, prepolymers) Among others, the hexa- or morefunctional (meth)acrylate compound is more preferably the urethane (meth)acrylate compound.

The hexa- or morefunctional (meth)acrylate compound preferably has a weight average molecular weight of 1000 or more If the weight average molecular weight of the hexa- or morefunctional (meth)acrylate compound is less than 1000, permeability into the substrate may increases, and therefore, adequate hardness may not be achieved. The weight average molecular weight is more preferably at least 1000 and at most 50000. The weight average molecular weight is furthermore preferably at least 1000 and at most 15000, and the most preferably at least 1000 and less than 6500. If it is more than 50000, viscosity of the composition is too high and it may be impossible to perform favorable coating.

The weight average molecular weight of the hexa- or morefunctional (meth)acrylate compound is determined on the polystyrene equivalent basis by a gel permeation chromatography method as with the above measuring method of the weight average molecular weight of the quaternary ammonium salt.

The hexa- or morefunctional (meth)acrylate compound is not particularly limited as long as it satisfies the conditions of the above-mentioned number of functional groups and weight average molecular weight, and publicly known (meth)acrylate compounds can be used. Further, the above urethane (meth)acrylate compound may be used alone or in combination of two or more species.

Among others, it is more preferable in the present invention to contain one or more hexa- or morefunctional urethane (meth)acrylate compounds having a weight average molecular weight of 1000 or more. By containing the urethane (meth)acrylate compound, adhesion between layers may become better and steel wool resistance may become better. The adhesion particularly becomes better when a low refractive index layer is formed on the hard coat layer in the optical layered body of the present invention.

Examples of commercially available products of the urethane (meth)acrylate compounds, which can be preferably used in the present invention, include SHIKOH series, such as UV-1700B, UV-6300B, UV-765B, UV-7640B and UV-7600B, produced by Nippon Synthetic Chemical Industry Co., Ltd.; Artresin series, such as Artresin HDP, Artresin UN-3320HSBA, UN-9000H, UN-952, Artresin UN-3320HA, Artresin UN-3320HB, Artresin UN-3320HC, Artresin UN-3320HS, Artresin UN-901M, Artresin UN-902MS and Artresin UN-903, produced by Negami Chemical Industrial Co., Ltd.; UA-100H, U-4H, U-4HA, U-6H, U-6HA, U-15HA, UA-32P, U-6LPA, U-324A and U-9HAMI produced by Shin-Nakamura Chemical Co., Ltd.; Ebecryl series, such as 1290, 5129, 254, 264, 265, 1259, 1264, 4866, 9260, 8210, 204, 205, 6602, 220 and 4450, produced by DAICEL-CYTEC Co., Ltd.; Beamset series, 371 and 577, produced by Arakawa Chemical Industries, Ltd.; RQ series produced by MITSUBISHI RAYON Co., Ltd.; UNIDIC series produced by Dainippon Ink and Chemicals Inc.; and DPHA-40H (produced by Nippon Kayaku Co., Ltd.), CN9006 (produced by Sartomer Co., Inc.) and CN968 (produced by Sartomer Co., Inc.) Of these, preferable examples include UV1700B (produced by Nippon Synthetic Chemical Industry Co., Ltd.), DPHA40H (produced by Nippon Kayaku Co., Ltd.), Artresin HDP (produced by Negami Chemical Industrial Co., Ltd.), Beamset 371 (produced by Arakawa Chemical Industries, Ltd.), Beamset 577 (produced by Arakawa Chemical Industries, Ltd.), and U15HA (produced by Shin-Nakamura Chemical Co., Ltd.).

In the present invention, it is conceivable that by containing the (meth)acrylate compound satisfying the above conditions of the number of functional groups and weight average molecular weight, particularly urethane (meth)acrylate compound, in addition to the (meth)acrylate compound as the binder resin, the (meth)acrylate compound having a low molecular weight is penetrated into the substrate together with a permeable solvent described later and the distribution of the hexa- or morefunctional urethane (meth)acrylate compound having a high molecular weight becomes biased toward the surface side of the hard coat layer when the hard coat layer-forming composition is applied onto the substrate. Therefore, by curing the hard coat layer-forming composition to form a resin layer, the interlaminar adhesion between the substrate and the hard coat layer becomes better, and generation of the interference fringes can be prevented because an interface between layers is not formed. Further, since the distribution of the hexa- or morefunctional urethane (meth)acrylate compound having a high molecular weight is biased toward the surface side of the hard coat layer, it is possible to impart suitably a desired hard-coating property to the resin layer to be formed.

When the (meth)acrylate compound is used in combination with the hexa- or morefunctional urethane (meth)acrylate compound, a mixing ratio (urethane (meth)acrylate compound/(meth)acrylate compound) of the hexa- or morefunctional urethane (meth)acrylate compound to the (meth)acrylate compound is preferably 5/95 to 90/10 in terms of solid weight ratio. If a proportion of the hexa- or morefunctional urethane (meth)acrylate compound is less than 5, the adhesion of the hard coat layer to layers (e.g., a hard coat layer, a high refractive index layer, an antifouling layer, and a low refractive index layer) formed above the hard coat layer may be deteriorated because a proportion of the (meth)acrylate compound increases. Further, when the (meth)acrylate compound is pentafunctional or hexafunctional, if a proportion of the (meth)acrylate compound is large, a large amount of heat of curing is generated, and therefore, the heat of curing may damage the substrate and cause the substrate to become crinkled. If the proportion of the hexa- or morefunctional urethane (meth)acrylate compound is more than 90, interference fringes may be generated and further adhesion to the substrate may be deteriorated because the proportion of the urethane (meth)acrylate compound increases.

The mixing ratio is more preferably 30/70 to 70/30.

The hard coat layer-forming composition contains a permeable solvent. The permeable solvent refers to a solvent which can exhibit a property of wetting or swelling a substrate to which a composition containing this solvent will be applied, or a solvent which can be permeated into the substrate. By using the permeable solvent, the interlaminar adhesion between the substrate and the hard coat layer can become better and the generation of interference fringes can be prevented.

Examples of the permeable solvent include ketones such as acetone, methyl ethyl ketone, cyclohexanone, methyl isobutyl ketone, diacetone alcohol, and the like; esters such as methyl formate, methyl acetate, ethyl acetate, butyl acetate, ethyl lactate, and the like; nitrogen-containing compounds such as nitromethane, acetonitrile, N-methylpyrrolidone, N,N-dimethylformamide, and the like; glycols such as methyl glycol, methyl glycol acetate, and the like; ethers such as tetrahydrofuran, 1,4-dioxane, dioxolane, diisopropyl ether, and the like; halogenated hydrocarbons such as methylene chloride, chloroform, tetrachloroethane, and the like; glycol ethers such as methyl cellosolve, ethyl cellosolve, butyl cellosolve, cellosolve acetate, and the like; and dimethyl sulfoxide, and propylene carbonate, or include mixtures thereof. Among others, the permeable solvent is preferably at least one selected from the group consisting of methyl acetate, ethyl acetate, butyl acetate, methyl ethyl ketone, methyl isobutyl ketone and cyclohexanone.

An amount of the permeable solvent to be added is preferably 30 to 500 parts by weight with respect to 100 parts by weight of the binder resin solid content in the hard coat layer-forming composition. If the amount of the permeable solvent is less than 30 parts by weight, coating becomes difficult to deteriorate a coated surface, and a problem of quality may arise. Further, interference fringes may be generated. If the amount of the solvent to be added is more than 500 parts by weight, an extent which the light-transmitting substrate is dissolved in the permeable solvent or swelled with the permeable solvent increases, and hardness may be deteriorated. Further, since the binder resin also permeates into the substrate, there is a possibility that an adequate crosslinking reaction is hardly developed and adequate hardness is not achieved.

The hard coat layer-forming composition may contain a light diffusing material. By containing the light diffusing material, the projection and depression configuration is formed at the surface of the hard coat layer and thereby it is possible to impart an antiglare property, i.e., external light diffusing properties, to the optical layered body, and by controlling the difference in refractive indexes between the light diffusing material and the binder resin, it is possible to impart internal light diffusing properties to the optical layered body. An antiglare layer may be newly formed separately from the hard coat layer having the antiglare property, and the antiglare layer may be formed between the hard coat layer and the light-transmitting substrate, or may be formed on the hard coat layer.

Examples of the light diffusing material include a fine particle which can form the projection and depression configuration at the surface of the layer. The shape of the fine particle is not particularly limited, and it may be spheric, elliptic, nonspherical or the like. The fine particle is preferably a transparent fine particle. The fine particle may include two or more species of fine particles.

As the light diffusing material, organic fine particles or inorganic fine particles can be used.

Examples of the organic fine particle include plastic beads. Examples of the plastic beads include a polystyrene bead (refractive index 1.60), a melamine bead (refractive index 1.57), an acrylic bead (refractive index 1.49 to 1.53), a acrylic-styrene bead (refractive index 1.53 to 1.58), a benzoguanamine-formaldehyde condensate bead (refractive index 1.66), a melamine-formaldehyde condensate bead (refractive index 1.66), a polycarbonate bead (refractive index 1.57), a polyethylene bead (refractive index 1.50), a polyvinyl chloride bead (refractive index 1.60), and the like. Among others, the acrylic-styrene bead is preferable as the plastic bead because its refractive index can be easily adjusted.

The plastic bead may have a hydrophobic group at its surface.

The organic fine particle preferably has an average particle diameter of 0.5 to 10 μm. The average particle diameter can be obtained by measuring with a Coulter counter.

Examples of the inorganic fine particles include nonspherical silica, an inorganic silica bead, and the like. As the nonspherical silica, a silica bead having an average particle diameter of 0.5 to 5 μm is preferable because its dispersibility is good. The above-mentioned average particle diameter is obtained by measuring with a Coulter counter.

Further, the nonspherical silica is more preferably nonspherical silica which becomes hydrophobic by treating the particle surface with organic substances in order to improve the dispersibility of the nonspherical silica without causing an increase in the viscosity of the hard coat layer-forming composition. As for the treatment with organic substances, there are a method of chemically bonding a compound to the bead surface and a physical method of impregnating voids existing in a composition composing the bead with a compound without chemically bonding a compound to the bead surface, and either method may be used. Generally, a chemical treatment method, in which an active group of the silica surface such as a hydroxyl group or a silanol group is utilized, is preferably used from the viewpoint of treatment efficiency. As compounds to be used for the treatment, silane materials, siloxane materials, or silazane materials, which are highly reactive with the active group, are used. Examples of the compounds include straight alkyl monosubstituted silicone materials such as methyltrichlorosilane, branched alkyl monosubstituted silicone materials, or polysubstituted straight alkyl silicone compounds such as di-n-butyldichlorosilane, ethyldimethylchlorosilane and the like, and polysubstituted branched alkyl silicone compounds. Similarly, straight alkyl or branched alkyl monosubstituted or polysubstituted siloxane materials or silazane materials can be effectively used.

A substance having a heteroatom, an unsaturated bonding group, a cyclic bonding group, or an aromatic functional group at the end or intermediate site of the alkyl chain may be used in accordance with a required function.

In these compound, it becomes possible to convert the material surface to be treated readily from hydrophilicity to hydrophobicity since the alkyl group contained in the compound exhibits hydrophobicity, and therefore, the compounds can attain high affinity for a polymeric material for which the compounds have low affinity in a state of being untreated.

Examples of commercialized products of the light diffusing material, which can be used in the present invention, include granular resin particles produced by NIPPON SHOKUBAI Co., Ltd. (EPOSTAR series), optics spherical particle produced by SEKISUI PLASTICS Co., Ltd. (MBX, SBX, MSX, MBX-S, MBX-SS series), silicone resin particles produced by NISSHO SANGYO Co. Ltd. (TOSPEARL series), silica particles produced by Fuji Silysia Chemical Ltd. (Sylysia series), nonspherical silica particles produced by Dainichiseika Color & Chemicals Mfg. Co., Ltd., AEROSIL produced by Degussa AG, and colloidal silica produced by Nissan Chemical Industries Co., Ltd. (SNOWTEX).

An amount of the light diffusing material to be added is preferably 1 to 40 parts by weight with respect to 100 parts by weight of the binder resin solid content. If the amount of the light diffusing material is less than 1 part by weight, there is a possibility that the antiglare property may not be adequately provided. If the amount of the light diffusing material is more than 40 parts by weight, haze becomes high, and therefore, there is a possibility that visibility is decreased in the case of providing the optical layered body of the present invention in an image display device. The amount of the light diffusing material is more preferably 1 to 20 parts by weight. In addition, when two or more species of light diffusing materials are contained, the above-mentioned amount of the light diffusing material to be added refers to a total amount of two or more species of light diffusing materials.

The hard coat layer-forming composition may contain other components as required in addition to the components described above. Examples of the other components include a photopolymerization initiator, a leveling agent, a crosslinking agent, a curing agent, a polymerization accelerator, a viscosity adjustor, an antistatic agent, and a resin other than the resins described above.

Examples of the photopolymerization initiator include acetophenones (for example, trade name Irgacure 184 (1-hydroxy-cylcohexyl-phenyl-ketone) produced by Ciba Specialty Chemicals K.K., trade name Irgacure 907 (2-methyl-1-[4-(methylthio)phenyl]-2-morpholino propan-1-one) produced by Ciba Specialty Chemicals K.K.), benzophenones, thioxanthones, benzoin, benzoin methyl ether, aromatic diazonium salt, aromatic sulfonium salt, aromatic iodonium salt, a metallocene compound, and benzoin sulfonate. These initiators may be used alone or in combination of two or more species.

An amount of the polymerizable compound to be used is preferably 0.1 to 10 parts by weight with respect to 100 parts by weight of the binder resin solid content.

As the above-mentioned leveling agent, crosslinking agent, curing agent, polymerization accelerator, viscosity adjustor, antistatic agent, and other resins, publicly known one may be used.

The hard coat layer-forming composition can be obtained by mixing and dispersing the quaternary ammonium salt having a weight average molecular weight of 1000 to 50000, the tri- or morefunctional (meth)acrylate compound having a weight average molecular weight of 700 or less, the permeable solvent and other components. A publicly known method such as a paint shaker or a beads mill can be used for mixing and dispersing.

The hard coat layer is preferably formed by applying the hard coat layer-forming composition onto a light-transmitting substrate or the like, described later, drying the composition as required, and curing the composition by irradiation of active energy rays.

Examples of a method of applying the hard coat layer-forming composition include application methods such as a roller coating method, a Myer bar coating method, a gravure coating method, and the like.

Examples of the irradiation of active energy rays include irradiation with ultraviolet light or an electron beam. Specific examples of an ultraviolet source include light sources such as an ultra high-pressure mercury lamp, a high-pressure mercury lamp, a low-pressure mercury lamp, a carbon arc lamp, a black light fluorescent lamp and a metal halide lamp. As the wavelength of the ultraviolet light, a wavelength band of 190 to 380 nm can be used. Specific examples of an electron beam source include various electron beam accelerators of a Cockcroft-Walton type, a van de Graaff type a resonance transformer type, an insulating core transformer type, or a linear type, a Dynamitron type and a high-frequency type.

A layer thickness of the hard coat layer is preferably 0.5 to 30 μm. If the layer thickness is less than 0.5 μm, not only coating irregularity is developed to make the appearance of a coat bad, but also the hardness of the layer may not be developed. Further, if the layer thickness is more than 30 μm, not only cracks are produced in the film itself or film winding becomes difficult, but also production cost becomes high. Further, this case is at risk of increasing haze and deteriorating light transmittance. The layer thickness is more preferably 1 to 20 μm.

A value of the layer thickness is obtained by observing a cross-section of the layer and measuring with an electron microscope (SEM, TEM, or STEM).

The optical layered body of the first present invention includes a light-transmitting substrate.

The light-transmitting substrate is preferably a substrate having smoothness and heat resistance, and superior in mechanical strength. Specific examples of materials for forming the light-transmitting substrate include cellulose compounds such as triacetyl cellulose, cellulose diacetate, and cellulose acetate butylate. Triacetyl cellulose is preferable.

The thickness of the light-transmitting substrate is preferably 20 to 300 μm, and more preferably 30 μm of the lower limit and 200 μm of the upper limit. The light-transmitting substrate may have be subjected to application of an anchor agent or a coating material referred to as a primer onto the substrate in advance, in addition to physical treatments such as a corona discharge treatment and an oxidation treatment, in order to improve the adhesive property of the substrate when the hard coat layer is formed on the substrate.

The optical layered body of the first present invention may further include an antistatic layer.

The antistatic layer is a layer which can imparting electrical conductivity to the optical layered body to prevent charging of the optical layered body so that adhesion of grit and dust, or the occurrence of a failure in a process step due to charging can be prevented. In the optical layered body of the present invention, one hard coat layer described above is enough for exerting antistatic performance, but the optical layered body may further have the antistatic layer.

The antistatic layer may be positioned between the light-transmitting substrate and the hard coat layer, or may be positioned on the hard coat layer formed on the light-transmitting substrate. The antistatic layer is a resin layer formed from an antistatic layer-forming composition containing an antistatic agent and a binder resin.

Examples of the antistatic agent include a quaternary ammonium salt, a pyridinium salt, and various cationic compounds having a cationic group such as a primary, a secondary, and a tertiary amino group; anionic compounds having an anionic group such as a sulfonate group, a sulfate group, a phosphate group and a phosphonate group; ampholytic compounds such as amino acid and aminosulfate; nonionic compounds such as amino alcohol, glycerin and polyethylene glycol; organic metal compounds such as alkoxide tin or titanium; and metal chelate compounds such as an acetylacetonate salt of the organic metal compound; and further include compounds formed by polymerizing the compounds described above. Further, polymerizable compounds such as monomer or oligomer which has a tertiary amino group, a quaternary ammonium group or a metal chelate moiety and is polymerizable with ionizing radiation, and organic metal compounds like a coupling agent having a functional group polymerizable with ionizing radiation can also be used as an antistatic agent. In addition, as a quaternary ammonium salt, the above quaternary ammonium salt having a weight average molecular weight of 1000 to 50000 may be used.

Examples of the antistatic agent include conductive ultrafine particles. Specific examples of conductive ultrafine particles include substances containing metal oxides. Examples of the metal oxides include ZnO (refractive index 1.90, hereinafter, a value in a parenthesis represents a refractive index), CeO₂ (1.95), Sb₂O₂ (1.71), SnO₂ (1.997), indium tin oxide (1.95) often abbreviated as ITO, In₂O₃ (2.00), Al₂O₃ (1.63), antimony-doped tin oxide (abbreviation; ATO, 2.0), aluminum-doped zinc oxide (abbreviation; AZO, 2.0), and the like. An ultrafine particle refers to a particle of 1 micron or smaller, that is sub micron, and is preferably a particle having an average particle diameter of 0.1 nm to 0.1 μm. Further, in accordance with a preferable aspect of the present invention, a primary particle diameter of the fine particle is about 30 to 70 nm, and a secondary particle diameter is about 200 nm or smaller.

Further, as the antistatic agent, organic conductive compositions can also be used. Examples of the organic conductive compositions include polymeric type conductive compositions. Examples of the organic conductive compositions further include aliphatic conjugated polyacetylene, aromatic conjugated poly(p-phenylene), heterocyclic conjugated polypyrrole, polythiophene, heteroatom-containing conjugated polyaniline, and mixed type conjugated poly(phenylenevinylene), other than the organic compounds described above. Furthermore, examples of the organic conductive compositions include a double chain conjugated compound which is a conjugated compound having a plurality of conjugate chains in a molecule, and a conductive complex which is a polymer prepared by grafting or block-copolymerizing the conjugated polymer chain to a saturated polymer.

As the binder resin for the antistatic layer, a transparent resin is preferable, and examples of the binder resin include, for example, ionizing radiation-curable resins which are resins to be cured with ultraviolet light or electron beams; a mixture of the ionizing radiation-curable resin and a solvent-drying resin (a resin, such as a thermoplastic resin, in which a coat is formed by only evaporating a solvent previously added in order to adjust a solid content during the application of the resin); and a thermosetting resin. More preferably, the binder resin is the ionizing radiation-curable resin. In addition, as used herein, the term “resin” includes resin components such as a monomer and an oligomer.

Examples of the ionizing radiation-curable resins include compounds having one or more unsaturated bonds such as compounds having acrylate functional groups. Examples of the compounds having one unsaturated bond include ethyl (meth)acrylate, ethylhexyl (meth)acrylate, styrenes methylstyrene, N-vinylpyrrolidone, and the like. Examples of the compounds having two or more unsaturated bonds include a polyfunctional compound such as polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate or neopentyl glycol di (meth)acrylate; and reaction products (for example, a poly(meth)acrylate ester of polyhydric alcohol) of the polyfunctional compound with (meth)acrylate, and the like. In addition, as used herein, “(meth)acrylate” refers to methacrylate or acrylate.

Besides the compound, a polyester resin, a polyether resin, an acrylic resin, an epoxy resin, a urethane resin, an alkyd resin, a spiroacetal resin, a polybutadiene resin, and a polythiol-polyen resin, which have an unsaturated double bond and a relatively low molecular weight, can also be used as the ionizing radiation-curable resin.

The ionizing radiation-curable resin can also be used in combination with the solvent-drying resin. By using the ionizing radiation-curable resin in combination with the solvent-drying resin, coat defects of a coated surface can be effectively prevented and thereby a more excellent gloss blackness can be attained. The solvent-drying resin, which can be used in combination with the ionizing radiation-curable resin, is not particularly limited, and a thermoplastic resin can be generally used.

The thermoplastic resin is not particularly limited, and examples of the thermoplastic resin include styrene resins, (meth) acrylic resins, vinyl acetate resins, vinyl ether resins, halogen-containing resins, alicyclic olefin resins, polycarbonate resins, polyester resins, polyamide resins, cellulose derivatives and silicone resins, rubbers or elastomers, and the like. The thermoplastic resin is preferably non-crystalline and soluble in organic solvents (particularly, common solvent in which a plurality of polymers or curable compounds can be dissolved). Particularly from the viewpoint of a film forming property, transparency and weather resistance, styrene resins, (meth)acrylic resins, alicyclic olefin resins, polyester resins, and cellulose derivatives (cellulose esters, etc.) are preferable.

In the optical layered body of the present invention, when the antistatic layer is formed on the light-transmitting substrate and a material of the light-transmitting substrate is a cellulose resin such as triacetyl cellulose (TAC), preferable specific examples of the thermoplastic resins include cellulose derivatives such as cellulose resins, for example, nitrocellulose, acetyl cellulose, cellulose acetate propionate, ethyl hydroxyethyl cellulose, acetylbutyl cellulose, ethyl cellulose, methyl cellulose, and the like. By using the cellulose resin, it is possible to improve the adhesion of the antistatic layer to the light-transmitting substrate or the hard coat layer, and transparency. Furthermore, besides the cellulose resins, examples of the thermoplastic resins include vinyl resins such as vinyl acetate and copolymers thereof, vinyl chloride and copolymers thereof, and vinylidene chloride and copolymers thereof, acetal resins such as polyvinyl formal, and polyvinyl butyral, acrylic resins such as an acrylic resin and copolymers thereof, a methacrylic resin and copolymers thereof, polystyrene resins, polyamide resins, polycarbonate resins, and the like.

Examples of the thermosetting resin, which can be used as the binder resin for an antistatic layer, include a phenol resin, a urea resin, a diallylphthalate resin, a melamine resin, a guanamine resin, an unsaturated polyester resin, a polyurethane resin, an epoxy resin, an aminoalkyd resin, a melamine-urea co-condensation resin, a silicon resin, a polysiloxane resin and the like.

The composition for antistatic layers may contain other components as required in addition to the components described above. Examples of the other components include a photopolymerization initiator, a leveling agent, a crosslinking agent, a curing agent, a polymerization accelerator, a viscosity adjustment agent, and the like.

A method of preparing the antistatic layer-forming compositions may be a method capable of mixing the above-mentioned components and a solvent uniformly, and the antistatic layer-forming compositions may be prepared according to a publicly known method. For example, the above-mentioned components can be mixed and dispersed in a solvent using the publicly known apparatus described above in the above-mentioned formation of the hard coat layer.

Examples of the solvent include water, alcohols (e.g. methanol, ethanol, propanol, isopropanol, n-butanol, s-butanol, t-butanol, benzyl alcohol, PGME), ketones (e.g. acetone, methyl ethyl ketone, methyl isobutyl ketone, cyclohexanone, heptanone, diisobutylketone, diethylketone), esters (e.g. methyl acetate, ethyl acetate, propyl acetate, butyl acetate, methyl formate, ethyl formate, propyl formate, butyl formate, PGMEA), aliphatic hydrocarbons (e.g. hexane, cyclohexane), halogenated hydrocarbons (e.g. methylene chloride, chloroform, carbon tetrachloride), aromatic hydrocarbons (e.g. benzene, toluene, xylene), amides (e.g. dimethylformamide, dimethyacetoamide, n-methylpyrrolidone), ethers (e.g. diethylether, dioxiane, tetrahydrofuran), etheralcohols (e.g. 1-methoxy-2-propanol), and the like.

As a method of forming the antistatic layer, a publicly known method may be employed. For example, the same various methods as in the formation method of the hard coat layer described above can be employed. Further, a method of curing a coat to be obtained may be appropriately selected in accordance with the content of the above-mentioned composition. For example, if the composition is ultraviolet-curable, the composition may be cured by ultraviolet irradiation to the coat.

The optical layered body of the first present invention may further include a low refractive index layer. The low refractive index layer is preferably formed on the hard coat layer or the antistatic layer. Thereby, it is possible to make optical properties such as antireflection performance, and the like in the optical layered body better. Further, when the low refractive index layer is formed on the hard coat layer, the optical layered body of the present invention is superior in the interlaminar adhesion between the hard coat layer and the low refractive index layer and is also superior in a antistatic property, hardness and optical property.

As the low refractive index layer, a layer having a lower refractive index than that of the hard coat layer is preferable. In accordance with a preferable aspect of the present invention, the refractive index of the hard coat layer is preferably 1.5 or more, and the refractive index of the low refractive index layer is less than 1.5, more preferably 1.45 or less, and furthermore preferably 1.35 or less.

The low refractive index layer may be composed of any of 1) a resin containing silica or magnesium fluoride, 2) a fluorine material being a low refractive index resin, 3) a fluorine material containing silica or magnesium fluoride, and 4) a thin film of silica or magnesium fluoride.

The fluorine material is a polymerizable compound containing fluorine atoms at least in a molecule or a polymer thereof. The polymerizable compound is not particularly limited, but a polymerizable compound having a curable and reactive group such as a functional group (ionizing radiation-curable group) to be cured with ionizing radiation or a polar group (heat-curable polar group) to be cured with heat is preferable. Further, compounds having these reactive groups simultaneously together may also be used.

As the polymerizable compounds having an ionizing radiation-curable group containing fluorine atoms, fluorine-containing monomers having an ethylenic unsaturated bond can be widely employed. More specifically, fluoroolefins (for example, fluoroethylene, vinylidene fluoride, tetrafluoroethylene, hexafluoropropylene, perfluorobutadiene, perfluoro-2,2-dimethyl-1,3-dioxole, etc.) can be exemplified. Examples of polymerizable compounds having a (meth)acryloyloxy group include a (meth)acrylate compound having fluorine atoms in a molecule such as 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluoroctyl)ethyl (meth)acrylate, 2-(perfluorodecyl)ethyl (meth)acrylate, α-trifluoromethyl methacrylate and α-trifluoroethyl methacrylate; and fluorine-containing polyfunctional (meth)acrylate compounds having a fluoroalkyl group, a fluorocycloalkyl group or a fluoroalkylene group, having 1 to 14 carbon atoms, which has at least three fluorine atoms in a molecule, and at least two (meth)acryloyloxy groups.

Examples of the polymerizable compounds having a heat-curable polar group containing fluorine atoms include 4-fluoroethylene-perfluoroalkylvinylether copolymer; fluoroethylene-hydrocarbonvinylether copolymer; and fluorine modified products of various resins such as epoxy, polyurethane, cellulose, phenol and polyimide. Preferable examples of the heat-curable polar group include groups for forming a hydrogen bond such as a hydroxyl group, a carboxyl group, an amino group and an epoxy group. These groups are superior in not only the adhesion to a coat but also the affinity for an inorganic ultra fine particle such as silica.

Examples of the polymerizable compounds (fluororesin) having the ionizing radiation-curable group and the heat-curable polar group together include partially and fully fluorinated alkyl, alkenyl, or aryl esters of acrylic acid or methacrylic acid, fully or partially fluorinated vinyl ethers, fully or partially fluorinated vinyl esters, fully or partially fluorinated vinyl ketones, and the like.

Examples of the polymer of the polymerizable compound containing fluorine atoms include polymers of a monomer or a mixture of monomers, containing at least one fluorine-containing (meth)acrylate compound of the polymerizable compounds having the ionizing radiation-curable group; copolymers of at least one fluorine-containing (meth)acrylate compound and a (meth)acrylate compound not containing a fluorine atom in a molecule such as methyl (meth)acrylate, ethyl (meth)acrylate, propyl (meth)acrylate, butyl (meth)acrylate and 2-ethylhexyl (meth)acrylate; and monopolymers or copolymers of a fluorine-containing monomer like fluoroethylene, vinylidene fluoride, trifluoroethylene, chlorotrifluoroethylene, 3,3,3-trifluoropropylene, 1,1,2-trichloro-3,3,3-trifluoropropylene and hexafluoropropylene.

Further, silicone-containing vinylidene fluoride copolymer prepared by containing a silicone component in these copolymers can also be used as a polymer of the polymerizable compound. Examples of the silicone component in this case include (poly)dimethylsiloxane, (poly)diethylsiloxane, (poly)diphenylsiloxane, (poly)methylphenylsiloxane, alkyl modified (poly)dimethylsiloxane, azo group-containing (poly)dimethylsiloxane, dimethylsilicone, phenylmethylsilicone, alkyl-aralkyl modified silicone, fluorosilicone, polyether modified silicone, aliphatic acid ester modified silicone, methyl hydrogen silicone, silanol group-containing silicone, alkoxy group-containing silicone, phenol group-containing silicone, methacryl modified silicone, acryl modified silicone, amino modified silicone, carboxylic acid modified silicone, carbinol modified silicone, epoxy modified silicone, mercapto modified silicone, fluorine modified silicone, polyether modified silicone, and the like. Among others, a silicone component having a dimethylsiloxane structure is preferable.

In addition to the compounds described above, compounds obtained by reacting a fluorine-containing compound having at least one isocyanate group in a molecule with a compound having at least one functional group which reacts with an isocyanate group, such as an amino group, a hydroxyl group or a carboxyl group, in a molecule; compounds obtained by reacting fluorine-containing polyol such as fluorine-containing polyether polyols, fluorine-containing alkyl polyols, fluorine-containing polyester polyols and fluorine-containing 531 -caprolactone modified polyol with a compound having an isocyanate group; and the like can be used as a fluororesin.

In forming the low refractive index layer, the low refractive index layer can be formed from a composition (a refractive index layer-forming composition) containing, for example, a raw material component. More specifically, a solution or a dispersion formed by dissolving and dispersing the raw material component (resin, etc.) and the additives (for example, “fine particles having voids” described later, a polymerization initiator, an antistatic agent, an antiglare agent, etc.) as required in a solvent is used as a low refractive index layer-forming composition, and a coat of the composition is formed, and the coat is cured, and thereby a low refractive index layer can be obtained. In addition, examples of the additives such as the polymerization initiator, the antistatic agent, and the antiglare agent include the additives publicly known.

Examples of the solvent include solvents which may be used in the formation of antistatic layers mentioned above. Among others, Methyl isobutyl ketone, methyl ethyl ketone, isopropyl alcohol (IPA), n-butanol, s-butanol, t-butanol, PGME, and PGMEA are preferably employed.

As a preparation method of the composition, a publicly known method may be used as long as the components can be uniformly mixed. For example, the components can be mixed using publicly known apparatus described in a paragraph of formation of the hard coat layer.

The method of forming the low refractive index layer has to follow a publicly known method. For example, various methods described in a paragraph of formation of the hard coat layer can be employed.

In the low refractive index layer, “fine particles having voids” are preferably used as a low refractive index agent. The “fine particles having voids” can reduce the refractive index of the refractive index layer while maintaining layer strength of the refractive index layer. In the present invention, the term “fine particles having voids” means particles having a structure in which the inside of the particle is filled with gas and/or a porous structure including gas is formed, and a characteristic that the refractive index is decreased in inverse proportion to a gas occupancy in the fine particle compared with the particle's own refractive index. In the present invention, a fine particle, in which a nano porous structure can be formed inside the coat and/or in at least a part of the coat surface, based on the configuration, the structure and the agglomeration condition of the fine particles and the state of dispersed particles in a coat, is included. The refractive index of the low refractive index layer using this particle can be adjusted to a refractive index of 1.30 to 1.45.

Examples of inorganic fine particles having voids include silica fine particles prepared by a method described in Japanese Kokai Publication 2001-233611. Silica fine particles prepared by a production method described in Japanese Kokai Publication Hei-7-133105, Japanese Kokai Publication 2002-79616, and Japanese Kokai Publication 2006-106714, may be used. Since the silica fine particle having voids is easily produced and has high particle's own hardness, layer strength thereof is enhanced and it becomes possible to adjust the refractive index to a range of about 1.20 to 1.45 when the particles are mixed with the binder resin to form the low refractive index layer. Particularly, specific preferable examples of organic fine particles having voids include hollow polymer particles prepared by use of a technology disclosed in Japanese Kokai Publication 2002-80503.

Examples of the particle, in which a nano porous structure can be formed inside the coat and/or in at least a part of the coat surface, include a slow-release agent produced for the purpose of increasing a specific surface area, in which various chemical substances is adsorbed on a column for filling and a porous portion of the surface, porous particles used for fixing a catalyst, and dispersed substances or agglomerated substances of hollow particles for the purpose of incorporating in a heat insulating material or a low dielectric material in addition to the silica particles. Specifically, it is possible to select and use the particles within the range of the preferable particle diameter of the present invention from agglomerated substances of porous silica particles of commercially available Nipsil or Nipgel (both trade name) produced by Nihon silica kogyo corporation and colloidal silica UP series (trade name), having a structure in which silica particles are linked with one another in a chain form, produced by Nissan Chemical Industries, Ltd.

An average particle diameter of the “fine particles having voids” is preferably 5 nm or more and 300 nm or less, and more preferably, a lower limit is 8 nm and an upper limit is 100 nm, even more preferably, a lower limit is 10 nm and an upper limit is 80 nm. It becomes possible to impart excellent transparency to the refractive index layer when the average particle diameter of the particles falls within this range. In addition, the average particle diameter is measured by a dynamic light-scattering method. An amount of the “fine particles having voids” is usually about 0.1 to 500 parts by weight with respect to 100 parts by weight of a matrix resin in the low refractive index layer, and preferably about 10 to 200 parts by weight.

In forming the low refractive index layer, it is preferable to set the viscosity of the low refractive index layer composition in a range of 0.5 to 5 cps (25° C.) where a preferable application property is attained, and more preferably 0.7 to 3 cps (25° C.). By setting the viscosity in this range, an excellent antireflection film of visible light can be realized, a uniform thin film can be formed without producing irregularity of application, and a low refractive index layer having particularly excellent adhesion to the substrate can be formed.

Means for curing a resin may be the same one as described in a paragraph of the hard coat layer. When heating means is used for curing the resin, preferably, a heat-polymerization initiator, which generates, for example, radicals by heat to initiate the polymerization of a polymerizable compound, is added to a fluororesin composition.

A film thickness (nm) d_{A} of the low refractive index layer preferably satisfies the following equation (I):

d_{A}=mλ/(4n_{A}) (I),

wherein n_{A} represents a refractive index of the low refractive index layer,
m represents a positive odd, and preferably 1,
λ is a wavelength, and preferably values from 480 nm to 580 nm.

Further, in the present invention, it is preferable from the viewpoint of reducing a reflection factor that the low refractive index layer satisfies the following equation (II):

120<n_{A}d_{A}<145 (II).

The optical layered body of the first present invention may include the antiglare layer. When the hard coat layer also serves as the antiglare layer, there may be cases where the antiglare layer is formed between the hard coat layer and the light-transmitting substrate or on the hard coat layer as a separate layer from the hard coat layer.

The antiglare layer is a layer for the purpose of inhibiting the deterioration of visibility due to image glare and reflection by external light, and due to scintillation or the like by having a projection and depression configuration on its surface.

Examples of a method of forming the projection and depression configuration on the surface include a method of forming projections and depressions using the light diffusing material, and a method of shaping the surface by embossing.

The antiglare layer is formed from an antiglare layer-forming composition obtained by dissolving or dispersing the binder resin, the light diffusing material and other components in a solvent.

Examples of the binder resin of the antiglare layer include the same resins as those which can be used for forming the antistatic layer described above.

Examples of the light diffusing material include the same light diffusing materials as those which can be used in the hard coat layer described above.

Examples of the solvent include the same solvents as those which can be used for forming the low refractive index layer described above.

A method of forming the antiglare layer is not particularly limited, and a publicly known method may be used, and examples of the method include the same method as the method of forming the hard coat layer described above.

The optical layered body in accordance with the first present invention includes the light-transmitting substrate and the hard coat layer, but it may include another hard coat layer, an antifouling layer, a high refractive index layer or a medium refractive index layer as an arbitrary layer as required in addition to the antistatic layer, the low refractive index layer and the antiglare layer described above. An antifouling agent, a high refractive index agent, a medium refractive index agent or a resin, usually used, is added to prepare compositions, and using these compositions, the antifouling layer, high refractive index layer and medium refractive index layer may be formed by a publicly known method.

A total light transmittance of the optical layered body of the first present invention is preferably 90% or more. If this transmittance is less than 90%, there is a possibility that color reproducibility and visibility are impaired in the case where the optical layered body is placed on the display surface. The total light transmittance is more preferably 95% or more, and furthermore preferably 98% or more.

The total light transmittance is measured by a method according to JIS K 7361 using a haze meter (manufactured by Murakami Color Research Laboratory Co., Ltd., trade no.; HM-150).

Haze of the optical layered body of the first present invention is preferably less than 1%, and more preferably less than 0.5%. Further, the haze in the case where an antiglare property is imparted to the optical layered body is preferably 0.5 to 75%, and more preferably 1 to 65%. When the optical layered body has the antiglare property, this haze includes both haze resulting from the projection and depression configuration and haze resulting from internal diffusion. The haze is measured by a method according to JIS K 7136 using a haze meter (manufactured by Murakami Color Research Laboratory Co., Ltd., trade no.; HM-150).

A surface resistivity of the optical layered body of the first present invention is preferably 10¹¹ Ω/square or less. If the surface resistivity is more than 10¹¹ Ω/square, there is a possibility that desired antistatic performance does not exert. The surface resistivity is more preferably 10⁹ Ω/square or less.

The surface resistivity is measured with a surface resistivity meter (manufactured by Mitsubishi Chemical Corp., trade no.; Hiresta IP MCP-HT260).

Further, in the optical layered body of the present invention, a saturated electrification quantity at the outermost surface is preferably less than 2.0 kV.

In the optical layered body of the present invention, if the saturated electrification quantity falls within the range described above, it is possible to effectively prevent dust from adhering to the outermost surface of the optical layered body even if the surface resistivity is more than 10¹¹ Ω/square.

When the saturated electrification quantity is 2.0 kV or more, particularly in a liquid crystal display of IPS mode, there is a possibility that display is vulnerable to distortion due to charging at the surface of a liquid crystal display because a voltage is applied between electrodes located in a horizontal direction.

The saturated electrification quantity is more preferably 1.5 kV or less, furthermore preferably 1.0 kV or less, and the most preferably 0.5 kV or less. When the saturated electrification quantity is 1.0 kV or less, the optical layered body is particularly effective as a surface film of IPS mode.

The saturated electrification quantity is measured according to JIS L 1094, and examples of a measuring method of the saturated electrification quantity include a half-life period measuring method. The half-life period measuring method is measured using commercially available measuring equipment such as STATIC HONESTMETER H-0110 (manufactured by SHISHIDO ELECTROSTATIC, Ltd., measuring conditions; applied voltage 10 kV, distance 20 mm, 25° C., 40% RH).

As for a specific measuring method, for example, a specimen (4 cm×4 cm) is fixed to a turntable, and a voltage is applied to the specimen while turning the table, and a withstand voltage (kV) of the surface of the specimen is measured with the above-mentioned measuring equipment. By drawing a decay curve of a withstand voltage for a time, the half-life period (the time lapsed until an electrification quantity reaches a half of an initial value) and the saturated electrification quantity can be measured.

The hardness of the optical layered body of the first present invention is preferably class H or higher in scratch hardness test by a pencil method (load 4.9 N) of JIS K 5600-5-4 (1999), more preferably class 2H or higher, and furthermore preferably class 3H or higher. In addition, when the optical layered body of the present invention is used in the outermost surface of an image display device, its hardness is preferably 2H or higher, and more preferably 3H or higher. Further, a smaller amount of abrasion of a test piece before and after the test in a T bar test according to JIS K 5400 is more preferable.

One aspect of the optical layered body of the first present invention is described by way of a drawing. FIG. 1 shows an optical layered body including a hard coat layer 1 and a light-transmitting substrate 2 from the top. The optical layered body of the present invention may have an optional layer in accordance with the purpose in addition to such the aspect, and is not limited to the aspect described above.

A method of producing an optical layered body of the first present invention includes the step of applying the hard coat layer-forming composition onto a light-transmitting substrate to form a hard coat layer.

The hard coat layer-forming composition contains a quaternary ammonium salt having a weight average molecular weight of 1000 to 50000, a tri- or more functional (meth)acrylate compound having a weight average molecular weight of 700 or less, and a permeable solvent.

Examples of the hard coat layer-forming composition include the same compositions as described above.

Examples of a method of forming the hard coat layer include the same formation methods as described above. The method of producing an optical layered body of the first present invention like this also constitutes the present invention.

The second present invention pertains to an optical layered body including a light-transmitting substrate, an antistatic layer and a hard coat layer, wherein the hard coat layer is a resin layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent, and wherein the content of the quaternary ammonium salt in the hard coat layer is 0.1 to 100 by weight. Therefore, an optical layered body which is superior in all antistatic performance, hardness and interlaminar adhesion can be formed.

That is, when the content of the quaternary ammonium salt in the hard coat layer is 0.1 to 100 by weight, antistatic performance can be remarkably improved with a small additive amount of the quaternary ammonium salt by further forming the antistatic layer. Further, in accordance with such a constitution of the second present invention, a robust layer can be formed without having an effect on optical properties and the hardness of the optical layered body can be also adequate The content of the quaternary ammonium salt is more preferably 0.1 to 50 by weight.

The optical layered body of the second present invention is formed from the same materials and by the same formation method as those in the optical layered body of the first present invention described above except for containing a quaternary ammonium salt in the hard coat layer in the specific amount described above and having the antistatic layer. The antistatic layer may be positioned between the light-transmitting substrate and the hard coat layer, or may be positioned on the hard coat layer formed on the light-transmitting substrate. When such the constitutions were employed, desired antistatic performance, hardness and interlaminar adhesion can be attained.

The optical layered body of the second present invention includes the light-transmitting substrate, the antistatic layer and the hard coat layer, and it may include an antiglare layer, a low refractive index layer, an antifouling layer, a high refractive index layer, a medium refractive index layer or another hard coat layer as an arbitrary layer as required. Examples of the above antiglare layer and the above low refractive index layer include the same antiglare layer and low refractive index layer as those which can be formed in the optical layered body of the first present invention described above. As the above-mentioned antifouling layer, high refractive index layer, medium refractive index layer or another hard coat layer, the same layers as those described in the optical layered body of the first present invention described above can be used.

In the optical layered body of the second present invention, its total light transmittance, haze, surface resistivity, saturated electrification quantity and hardness are preferably similar to those of the optical layered body of the first present invention described above.

One aspect of the optical layered body of the second present invention is shown in FIGS. 2 and 3. FIG. 2 shows an optical layered body including an antistatic layer 3, a hard coat layer 1, and a light-transmitting substrate 2 from the top. FIG. 3 shows an optical layered body including a hard coat layer 1, an antistatic layer 3, and a light-transmitting substrate 2 from the top. The optical layered body of the present invention may have an optional layer in accordance with the purpose in addition to such the aspects, and is not limited to the aspects described above.

A method of producing the optical layered body of the second present invention includes the steps of applying an antistatic layer-forming composition onto a light-transmitting substrate to form an antistatic layer, and applying a hard coat layer-forming composition onto the antistatic layer to form a hard coat layer.

Further, the method of producing the optical layered body of the second present invention may include the steps of applying a hard coat layer-forming composition onto a light-transmitting substrate to form a hard coat layer, and applying an antistatic layer-forming composition onto the hard coat layer to form an antistatic layer.

As the hard coat layer-forming composition and antistatic layer-forming composition, the same compositions as those which can be used in the optical layered body of the first present invention described above can be used.

The hard coat layer and the antistatic layer can be formed by the same formation methods as those of the respective layers described above.

These methods of producing the optical layered body of the second present invention also constitute the present invention.

The optical layered body of the first and second present inventions can be formed into a polarizer by providing the optical layered body on the side opposite to the side where the hard coat layer in the optical layered body exists on the surface of a polarizing element. The polarizer like this also constitutes the present invention.

The polarizing element is not particularly limited, and as the polarizing element, for example, a polyvinyl alcohol film, a polyvinyl formal film, a polyvinyl acetal film or an ethylene-vinyl acetate copolymer saponified film, which is dyed with iodine or the like and stretched, can be used. In laminating the polarizing element and the optical layered body of the present invention, preferably, the light-transmitting substrate (preferably triacetyl cellulose film) is subjected to a saponification treatment. The adhesive property between the polarizing element and the optical layered body becomes good by the saponification treatment, and thus an antistatic effect can be attained.

The present invention also provides an image display device including the optical layered body or the polarizer at the outermost surfaces. The image display device may be a non-self-luminous image display device such as LCD, or may be a self-luminous image display device such as PDP, FED, ELD (organic EL, inorganic EL) and CRT.

The LCD, which is a typical example of the non-self-luminous type, includes a light-transmitting display and a light source apparatus to irradiate the light-transmitting display from the backside. When the image display device of the present invention is an LCD, the optical layered body of the present invention or the polarizer of the present invention is formed on the surface of this light-transmitting display.

When the present invention provides a liquid crystal display device having the optical layered body, a light source of the light source apparatus irradiates from the side on which the light-transmitting substrate exists of the optical layered body. In addition, in the STN type liquid crystal display device, a retardation plate may be inserted between a liquid crystal display element and the polarizer. An adhesive layer may be provided between the respective layers of this liquid crystal display device as required.

The PDP, which is the self-luminous image display device, includes a surface glass substrate (electrode is formed on the surface) and a backside glass substrate which is located at a position opposite to the surface glass substrate (an electrode and fine grooves are formed in the surface and red-, green-, and blue-phosphor layers are formed in the grooves) with a discharge gas filled between these substrates. When the image display device of the present invention is a PDP, the PDP includes the optical layered body described above on the surface of the surface glass substrate or a front plate (glass substrate or film substrate) thereof.

The self-luminous image display device may be an ELD apparatus in which luminous substances of zinc sulfide or diamines materials to emit light through the application of a voltage are deposited on a glass substrate by vapor deposition and display is performed by controlling a voltage to be applied to the substrate, or image display devices such as CRT, which converts electric signals to light to generate visible images. In this case, the image display device includes the optical layered body described above on the outermost surface of each of the display devices or on the surface a front plate thereof.

The image display device of the present invention can be used for displays such as televisions, computers, and word processors in any case. Particularly, it can be suitably used for the surfaces of displays for high-resolution images such as CRTs, liquid crystal panels, PDPs, ELDs and FEDs.

### EFFECTS OF THE INVENTION

The optical layered body of the present invention is superior to antistatic property, hardness, and optical properties such as haze. Accordingly, the optical layered body of the present invention can be preferably used for a cathode-ray tube (CRT) display device, a liquid crystal display (LCD), a plasma display (PDP), an electroluminescence display (ELD), a field emission display (FED), and the like.

### BRIEF DESCRIPTIONS OF THE DRAWINGS

FIG. 1 is an example of a schematic view of a cross section of an optical layered body of the first present invention.

FIG. 2 is an example of a schematic view of a cross section of an optical layered body of the second present invention.

FIG. 3 is an example of a schematic view of a cross section of the optical layered body of the second present invention.

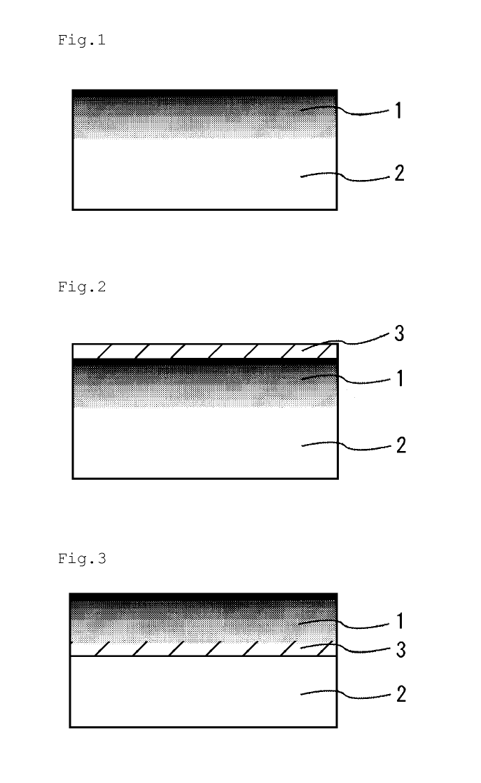

### EXPLANATION OF THE NUMERICAL SYMBOLS

1 Hard coat layer
2 Light-transmitting substrate
3 Antistatic layer

### BEST MODE FOR CARRYING OUT THE INVENTION

Contents of the present invention will be described based on the following examples, but the contents of the present invention are not to be construed to limited to these embodiments. “Part(s)” and “%” refer to “part(s) by weight” and “% by weight”, unless otherwise specified.

Hard coat layer-forming compositions 1 to 22 were prepared based on the composition shown in Production Examples 1 to 22.

### PRODUCTION EXAMPLE 1

### Hard Coat Layer-Forming Composition 1

| | |
|---|---|
| Urethane acrylate (UV-1700B; produced by Nippon Synthetic | 4 parts by weight |
| Chemical Industry Co., Ltd., decafunctional, weight average | |
| molecular weight 2000) | |
| Dipentaerithritol hexaacrylate (DPHA; produced by Nippon | 3 parts by weight |
| Kayaku Co., Ltd., hexafunctional, weight average molecular | |
| weight 524) | |
| Antistatic agent (H6100; produced by Mitsubishi Chemical Corp., | 6 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 0.4 parts by weight |
| Specialty Chemicals K.K.) | |
| Methyl ethyl ketone | 7 parts by weight |

(* A quaternary ammonium salt component exists in an amount of 6.1% in a solid content)

### PRODUCTION EXAMPLE 2

### Hard Coat Layer-Forming Composition 2

| | |
|---|---|
| Urethane acrylate (UV-1700B; produced by Nippon Synthetic | 5 parts by weight |
| Chemical Industry Co., Ltd., decafunctional, weight average | |
| molecular weight 2000) | |
| Dipentaerithritol hexaacrylate (DPHA; produced by Nippon | 4.5 parts by weight |
| Kayaku Co., Ltd., hexafunctional, weight average molecular | |
| weight 524) | |
| Antistatic agent (H6100; produced by Mitsubishi Chemical Corp., | 1 part by weight |
| weight average molecular weight 1500, solid content 50%, A | |
| content of quaternary ammonium salt component is 21% in a solid | |
| content) | |
| Polymerization initiator (Irgacure 184; produced by Ciba | 0.4 parts by weight |
| Specialty Chemicals K.K.) | |
| Methyl ethyl ketone | 7 parts by weight |

(* A quaternary ammonium salt component exists in an amount of 1.0% in a solid content)

### PRODUCTION EXAMPLE 3

### Hard Coat Layer-Forming Composition 3

| | |
|---|---|
| Urethane acrylate (BS (Beamset) 577; produced by Arakawa | 4 parts by weight |
| Chemical Industries, Ltd., hexafunctional, weight average | |
| molecular weight 1000) | |
| Dipentaerithritol hexaacrylate (DPHA; produced by Nippon | 3 parts by weight |
| Kayaku Co., Ltd., hexafunctional, weight average molecular | |
| weight 524) | |
| Antistatic agent (H6100; produced by Mitsubishi Chemical Corp., | 6 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 0.4 parts by weight |
| Specialty Chemicals K.K.) | |
| Methyl ethyl ketone | 7 parts by weight |

(* A quaternary ammonium salt component exists in an amount of 6.1% in a solid content)

### PRODUCTION EXAMPLE 4

### Hard Coat Layer-Forming Composition 4

| | |
|---|---|
| Urethane acrylate (UV-1700B; produced by Nippon Synthetic | 4 parts by weight |
| Chemical Industry Co., Ltd., decafunctional, weight average | |
| molecular weight 2000) | |
| Isocyanuric acid modified triacrylate (Aronix M-315; produced | 3 parts by weight |
| by Toagosei Co., Ltd., trifunctional, weight average molecular | |
| weight 423) | |
| Antistatic agent (H6100; produced by Mitsubishi Chemical Corp., | 6 parts by weight |
| weight average molecular weight 1500, solid content 50%, A | |
| content of quaternary ammonium salt component is 10%) | |
| Polymerization initiator (Irgacure 184; produced by Ciba | 0.4 parts by weight |
| Specialty Chemicals K.K.) | |
| Methyl ethyl ketone | 7 parts by weight |

(* A quaternary ammonium salt component exists in an amount of 6.1% in a solid content)

### PRODUCTION EXAMPLE 5

### Hard Coat Layer-Forming Composition 5

| | |
|---|---|
| Urethane acrylate (UV-1700B; produced by Nippon Synthetic | 4 parts by weight |
| Chemical Industry Co., Ltd., decafunctional, weight average | |
| molecular weight 2000) | |
| Dipentaerithritol hexaacrylate (DPHA; produced by Nippon | 3 parts by weight |
| Kayaku Co., Ltd., hexafunctional, weight average molecular | |
| weight 524) | |
| Antistatic agent (H6100; produced by Mitsubishi Chemical Corp., | 6 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 0.4 parts by weight |
| Specialty Chemicals K.K.) | |
| Methyl ethyl ketone | 7 parts by weight |

(* A quaternary ammonium salt component exists in an amount of 6.1% in a solid content)

### PRODUCTION EXAMPLE 6

### Hard Coat Layer-Forming Composition 6

Urethane acrylate

| | |
|---|---|
| (UN-3320HSBA; produced by Negami Chemical Industrial Co., Ltd., | 2 parts by weight |
| pentadecafunctional, weight average molecular weight 5000) | |
| (BS 577; produced by Arakawa Chemical Industries, Ltd., | 2 parts by weight |
| hexafunctional, weight average molecular weight 1000) | |
| Dipentaerithritol hexaacrylate (DPHA; produced by Nippon | 1.5 parts by weight |
| Kayaku Co., Ltd., hexafunctional, weight average molecular | |
| weight 524) | |
| Polyester acrylate (M-9050; produced by TOAGOSEI Co., Ltd., | 1.5 parts by weight |
| trifunctional, weight average molecular weight 400 to 430) | |
| Antistatic agent (H6100; produced by Mitsubishi Chemical Corp., | 6 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 0.4 parts by weight |
| Specialty Chemicals K.K.) | |
| Methyl ethyl ketone | 7 parts by weight |

(* A quaternary ammonium salt component exists in an amount of 6.1% in a solid content)

### PRODUCTION EXAMPLE 7

### Hard Coat Layer-Forming Composition 7

| | |
|---|---|
| Dipentaerithritol hexaacrylate (DPHA; produced by Nippon | 1.3 parts by weight |
| Kayaku Co., Ltd., hexafunctional, weight average molecular | |
| weight 524) | |
| Antistatic agent (H6100; produced by Mitsubishi Chemical Corp., | 2.7 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 0.1 part by weight |
| Specialty Chemicals K.K.) | |
| Polymerization initiator (Irgacure 907; produced by Ciba | 0.05 parts by weight |
| Specialty Chemicals K.K.) | |
| Cyclohexanone | 1.6 parts by weight |
| Propylene glycol monomethyl ether (PGME) | 7.2 parts by weight |

(* A quaternary ammonium salt component exists in an amount of 10.1% in a solid content)

### PRODUCTION EXAMPLE 8

### Hard Coat Layer-Forming Composition 8

| | |
|---|---|
| Urethane acrylate (UV-1700B; produced by Nippon Synthetic | 0.37 parts by weight |
| Chemical Industry Co., Ltd., decafunctional, weight average | |
| molecular weight 2000) | |
| Dipentaerithritol hexaacrylate (DPHA; produced by Nippon | 0.93 parts by weight |
| Kayaku Co., Ltd., hexafunctional, weight average molecular | |
| weight 524) | |
| Antistatic agent (H6100; produced by Mitsubishi Chemical Corp., | 2.6 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 0.1 part by weight |
| Specialty Chemicals K.K.) | |
| Polymerization initiator (Irgacure 907; produced by Ciba | 0.05 parts by weight |
| Specialty Chemicals K.K.) | |
| Cyclohexanone | 1.6 parts by weight |
| Propylene glycol monomethyl ether (PGME) | 7.2 parts by weight |

(* A quaternary ammonium salt component exists in an amount of 9.9% in a solid content)

### PRODUCTION EXAMPLE 9

### Hard Coat Layer-Forming Composition 9

| | |
|---|---|
| Pentaerithritol triacrylate (PETA; produced by Nippon Kayaku | 1.6 parts by weight |
| Co., Ltd.) | |
| Antistatic agent (H6100; produced by Mitsubishi Chemical Corp., | 3.2 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 0.17 parts by weight |
| Specialty Chemicals K.K.) | |
| Polymerization initiator (Irgacure 907; produced by Ciba | 0.047 parts by weight |
| Specialty Chemicals K.K.) | |
| Acrylic-styrene bead (XX-136C; produced by SEKISUI PLASTICS Co., | 0.6 parts by weight |
| Ltd., average particle diameter 5.5 μm, refractive index 1.55) | |
| Nonspherical silica (average particle diameter 1.7 μm) | 0.08 parts by weight |
| Polyether modified silicone oil (10% solution diluted with | 0.008 parts by weight |
| toluene; produced by Shin-Etsu Chemical Co., Ltd.) | |
| Cyclohexanone | 1.9 parts by weight |
| Methyl isobutyl ketone (MIBK) | 1.4 parts by weight |
| n-butanol | 2.8 parts by weight |
| Isopropyl alcohol (IPA) | 3.3 parts by weight |

(* A quaternary ammonium salt component exists in an amount of 8.2% in a solid content)

### PRODUCTION EXAMPLE 10

### Hard Coat Layer-Forming Composition 10

| | | |
|---|---|---|
| Urethane acrylate (UV-1700B; produced by Nippon Synthetic | 0.32 | parts by weight |
| Chemical Industry Co., Ltd., decafunctional, weight average | | |
| molecular weight 2000) | | |
| Pentaerithritol triacrylate (PETA; produced by Nippon Kayaku | 1.28 | parts by weight |
| Co., Ltd.) | | |
| Antistatic agent (H6100; produced by Mitsubishi Chemical Corp., | 3.2 | parts by weight |
| weight average molecular weight 1500, solid content 50%, A | | |
| content of quaternary ammonium salt component is 21% in a solid | | |
| content) | | |
| Polymerization initiator (Irgacure 184; produced by Ciba | 0.17 | parts by weight |
| Specialty Chemicals K.K.) | | |
| Polymerization initiator (Irgacure 907; produced by Ciba | 0.047 | parts by weight |
| Specialty Chemicals K.K.) | | |
| Acrylic-styrene bead (XX-136C; produced by SEKISUI PLASTICS Co., | 0.6 | parts by weight |
| Ltd., average particle diameter 5.5 μm, refractive index 1.55) | | |
| Nonspherical silica (average particle diameter 1.7 μm) | 0.08 | parts by weight |
| Polyether modified silicone oil (10% solution diluted with | 0.008 | parts by weight |
| toluene; produced by Shin-Etsu Chemical Co., Ltd.) | | |
| Cyclohexanone | 1.9 | parts by weight |
| Methyl isobutyl ketone (MIBK) | 1.4 | parts by weight |
| n-butanol | 2.8 | parts by weight |
| Isopropyl alcohol (IPA) | 3.3 | parts by weight |

(* A quaternary ammonium salt component exists in an amount of 8.2% in a solid content)

### PRODUCTION EXAMPLE 11

### Hard Coat Layer-Forming Composition 11

| | | |
|---|---|---|
| Urethane acrylate (UV-1700B; produced by Nippon Synthetic | 4 | parts by weight |
| Chemical Industry Co., Ltd., decafunctional, weight average | | |
| molecular weight 2000) | | |
| Dipentaerithritol hexaacrylate (DPHA; produced by Nippon | 3 | parts by weight |
| Kayaku Co., Ltd., hexafunctional, weight average molecular | | |
| weight 524) | | |
| Antistatic agent (H6100; produced by Mitsubishi Chemical Corp., | 2.5 | parts by weight |
| weight average molecular weight 1500, solid content 50%, A | | |
| content of quaternary ammonium salt component is 21% in a solid | | |
| content) | | |
| Polymerization initiator (Irgacure 184; produced by Ciba | 0.28 | parts by weight |
| Specialty Chemicals K.K.) | | |
| Polymerization initiator (Irgacure 907; produced by Ciba | 0.14 | parts by weight |
| Specialty Chemicals K.K.) | | |
| Nonspherical silica (average particle diameter 1.7 μm) | 0.48 | parts by weight |
| Polyether modified silicone oil (10% solution diluted with | 0.016 | parts by weight |
| toluene; produced by Shin-Etsu Chemical Co., Ltd.) | | |
| Methyl ethyl ketone | 7 | parts by weight |

(* A quaternary ammonium salt component exists in an amount of 2.9% in a solid content)

### PRODUCTION EXAMPLE 12

### Hard Coat Layer-Forming Composition 12

| | | |
|---|---|---|
| Dipentaerithritol hexaacrylate (DPHA; produced | 0.4 | parts by weight |
| by Nippon Kayaku Co., Ltd., hexafunctional, | | |
| weight average molecular weight 524) | | |
| Antistatic agent (H6100; produced by Mitsubishi | 4.4 | parts by weight |
| Chemical Corp., weight average molecular | | |
| weight 1500, solid content 50%, A content of | | |
| quaternary ammonium salt component is 21% | | |
| in a solid content) | | |
| Polymerization initiator (Irgacure 184; produced | 0.05 | parts by weight |
| by Ciba Specialty Chemicals K.K.) | | |
| Polymerization initiator (Irgacure 907; produced | 0.052 | parts by weight |
| by Ciba Specialty Chemicals K.K.) | | |
| Cyclohexanone | 1.9 | parts by weight |
| Propylene glycol monomethyl ether (PGME) | 6.2 | parts by weight |

(* A quaternary ammonium salt component exists in an amount of 17.1% in a solid content)

### PRODUCTION EXAMPLE 13

### Hard Coat Layer-Forming Composition 13

| | |
|---|---|
| Urethane acrylate (UN-952; produced by Negami | 4 parts by weight |
| Chemical Industrial Co., Ltd., decafunctional, | |
| weight average molecular weight 6500 to 11000) | |
| Dipentaerithritol hexaacrylate (DPHA; produced | 3 parts by weight |
| by Nippon Kayaku Co., Ltd., hexafunctional, | |
| weight average molecular weight 524) | |
| Antistatic agent (H6100; produced by Mitsubishi | 6 parts by weight |
| Chemical Corp., weight average molecular | |
| weight 1500, solid content 50%, A content of | |
| quaternary ammonium salt component is 21% | |
| in a solid content) | |
| Polymerization initiator (Irgacure 184; produced | 0.4 parts by weight |
| by Ciba Specialty Chemicals K.K.) | |
| Methyl ethyl ketone | 7 parts by weight |

(* A quaternary ammonium salt component exists in an amount of 6.1% in a solid content)

### PRODUCTION EXAMPLE 14

### Hard Coat Layer-Forming Composition 14

| | |
|---|---|
| 1,6-hexanedioldiacrylate (HDDA; produced by | 6 parts by weight |
| DAICEL-CYTEC Co., Ltd., difunctional, | |
| weight average molecular weight 226) | |
| Antistatic agent (H6100; produced by Mitsubishi | 6 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 0.4 parts by weight |
| by Ciba Specialty Chemicals K.K.) | |
| Methyl ethyl ketone | 7 parts by weight |

(* A quaternary ammonium salt component exists in an amount of 6.7% in a solid content)

### PRODUCTION EXAMPLE 15

### Hard Coat Layer-Forming Composition 15

| | |
|---|---|
| Urethane acrylate (UV-1700B; produced by | 4 parts by weight |
| Nippon Synthetic Chemical Industry Co., Ltd., | |
| decafunctional, weight average molecular | |
| weight 2000) | |
| Dipentaerithritol hexaacrylate (DPHA; produced | 3 parts by weight |
| by Nippon Kayaku Co., Ltd., hexafunctional, | |
| weight average molecular weight 524) | |
| Antistatic agent (H6100; produced by Mitsubishi | 6 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 0.4 parts by weight |
| by Ciba Specialty Chemicals K.K.) | |
| Toluene | 7 parts by weight |

(* A quaternary ammonium salt component exists in an amount of 6.1% in a solid content)

### PRODUCTION EXAMPLE 16

### Hard Coat Layer-Forming Composition 16

| | |
|---|---|
| Urethane acrylate (UX-8101D; produced by | 8 parts by weight |
| Nippon Synthetic Chemical Industry Co., Ltd., | |
| difunctional, weight average molecular | |
| weight 5000 or more) | |
| Antistatic agent (H6100; produced by Mitsubishi | 6 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 0.4 parts by weight |
| by Ciba Specialty Chemicals K.K.) | |
| Methyl ethyl ketone | 7 parts by weight |

(* A quaternary ammonium salt component exists in an amount of 5.5% in a solid content)

### PRODUCTION EXAMPLE 17

### Hard Coat Layer-Forming Composition 17

| | |
|---|---|
| Urethane acrylate (UV-1700B; produced by | 6.8 parts by weight |
| Nippon Synthetic Chemical Industry Co., Ltd., | |
| decafunctional, weight average molecular | |
| weight 2000) | |
| Dipentaerithritol hexaacrylate (DPHA; produced | 3 parts by weight |
| by Nippon Kayaku Co., Ltd., hexafunctional, | |
| weight average molecular weight 524) | |
| Antistatic agent (H6100; produced by Mitsubishi | 0.2 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced by | 0.4 parts by weight |
| Ciba Specialty Chemicals K.K.) | |
| Methyl ethyl ketone | 7 parts by weight |

(* A quaternary ammonium salt component exists in an amount of 0.2% in a solid content)

### PRODUCTION EXAMPLE 18

### Hard Coat Layer-Forming Composition 18

| | | |
|---|---|---|
| Antistatic agent (trade name; ASHD300S, ATO | 9.5 | parts by weight |
| dispersant, produced by The Inctec Inc.) | | |
| Dipentaerithritol hexaacrylate (DPHA; produced | 100 | parts by weight |
| by Nippon Kayaku Co., Ltd., hexafunctional, | | |
| weight average molecular weight 524) | | |
| Polymerization initiator (Irgacure 184; produced | 4 | parts by weight |
| by Ciba Specialty Chemicals K.K.) | | |
| Cyclohexanone | 100 | parts by weight |

### PRODUCTION EXAMPLE 19

### Hard Coat Layer-Forming Composition 19

| | | |
|---|---|---|
| Antistatic agent (H6100; produced by Mitsubishi | 5.1 | part by weight |
| Chemical Corp., weight average molecular weight | | |
| 1500, solid content 50%, A content of quaternary | | |
| ammonium salt component is 21% in a solid | | |
| content) | | |
| Polymerization initiator (Irgacure 184; produced | 0.05 | parts by weight |
| by Ciba Specialty Chemicals K.K.) | | |
| Polymerization initiator (Irgacure 907; produced | 0.052 | parts by weight |
| by Ciba Specialty Chemicals K.K.) | | |
| Cyclohexanone | 1.8 | parts by weight |
| Propylene glycol monomethyl ether (PGME) | 6.0 | parts by weight |

(* A quaternary ammonium salt component exists in an amount of 20.2% in a solid content)

### PRODUCTION EXAMPLE 20

### Hard Coat Layer-Forming Composition 20

| | |
|---|---|
| Urethane acrylate (Ebecryl 5129; produced by | 4 parts by weight |
| DAICEL-CYTEC Co., Ltd., hexafunctional, | |
| weight average molecular weight 800) | |
| Dipentaerithritol hexaacrylate (DPHA; produced | 3 parts by weight |
| by Nippon Kayaku Co., Ltd., hexafunctional, | |
| weight average molecular weight 524) | |
| Antistatic agent (H6100; produced by Mitsubishi | 6 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 0.4 parts by weight |
| by Ciba Specialty Chemicals K.K.) | |
| Methyl ethyl ketone | 7 parts by weight |

(* A quaternary ammonium salt component exists in an amount of 6.1% in a solid content)

### PRODUCTION EXAMPLE 21

### Hard Coat Layer-Forming Composition 91

| | |
|---|---|
| Urethane acrylate (Ebecryl 8210; produced by | 4 parts by weight |
| DAICEL-CYTEC Co., Ltd., tetrafunctional, | |
| weight average molecular weight 600) | |
| Dipentaerithritol hexaacrylate (DPHA; produced | 3 parts by weight |
| by Nippon Kayaku Co., Ltd., hexafunctional, | |
| weight average molecular weight 524) | |
| Antistatic agent (H6100; produced by Mitsubishi | 6 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 0.4 parts by weight |
| by Ciba Specialty Chemicals K.K.) | |
| Methyl ethyl ketone | 7 parts by weight |

(* A quaternary ammonium salt component exists in an amount of 6.1% in a solid content)

### PRODUCTION EXAMPLE 22

### Hard Coat Layer-Forming Composition 22

| | |
|---|---|
| Pentaerithritol tetraacrylate (VISCOAT 400; | 7 parts by weight |
| produced by OSAKA ORGANIC CHEMICAL | |
| INDUSTRY Ltd., tetrafunctional, weight | |
| average molecular weight 352.3) | |
| Antistatic agent (H6100; produced by Mitsubishi | 6 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 0.4 parts by weight |
| by Ciba Specialty Chemicals K.K.) | |
| Methyl ethyl ketone | 7 parts by weight |

(* A quaternary ammonium salt component exists in an amount of 6.1% in a solid content)

### EXAMPLE 1

### Production of Optical Layered Body

A transparent substrate (a triacetyl cellulose resin film (TF 80UL, produced by FUJIFILM Corp.) having a thickness of 80 μm) was prepared, the hard coat layer-forming composition 1 was applied onto one side of the film, and the applied composition on the film was dried for 60 seconds in a hot oven of 50° C. to evaporate the solvent in a coat, and then the coat was cured by irradiating ultraviolet light to the coat in such a way that an accumulated light quantity is 50 mJ to form an antistatic hard coat layer of 15 g/cm² (as a dried film thickness) to prepare an optical layered body.

### EXAMPLES 2 TO 11

Optical layered bodies were produced by the same procedure as in Example 1 except for using the hard coat layer-forming compositions 2 to 11 in place of the composition 1 and forming an antistatic hard coat layer in an application amount shown in Table 1.

### EXAMPLE 12

The following over coating formulation A was applied onto the hard coat layer prepared in Example 1, and then the applied formulation A on the hard coat layer was dried for 60 seconds in a hot oven of 50° C. to evaporate the solvent in a coat, and then the coat was cured by irradiating ultraviolet light to the coat in such a way that an accumulated light quantity is 50 mJ to form an over coating layer of 0.2 g/cm² (as a dried film thickness) to prepare an optical layered body.

### <Over Coating (Hard Coat) Formulation A>

| | |
|---|---|
| Pentaerithritol triacrylate (PET-30; produced by | 10 parts by weight |
| Nippon Kayaku Co., Ltd.) | |
| Polymerization initiator (Irgacure 184; produced by | 0.4 parts by weight |
| Ciba Specialty Chemicals K.K.) | |
| Methyl ethyl ketone | 15 parts by weight |

### EXAMPLE 13

An optical layered body was produced by the same procedure as in Example 12 except for using the following over coating formulation B in place of the over coating formulation A in Example 12.

### PRODUCTION EXAMPLE

### Over Coating (Low Refractive Index Resin) Formulation B

| | | |
|---|---|---|
| Treated silica fine particle “having voids” (A | 11.5 | parts by weight |
| solid content of the silica fine particle is 20% | | |
| by weight of a solution; methyl isobutyl ketone, | | |
| particle diameter 50 nm) | | |
| Pentaerithritol triacrylate (PETA) | 1.58 | parts by weight |
| Polymerization initiator (Irgacure 127; produced | 0.1 | part by weight |
| by Ciba Specialty Chemicals K.K.) | | |
| Silicone oil (X-22-164E; produced by Shin-Etsu | 0.1 | part by weight |
| Chemical Co., Ltd.) | | |
| Methyl isobutyl ketone | 32 | parts by weight |
| Propylene glycol monomethyl ether (PGME) | 20 | parts by weight |

### EXAMPLE 14

A transparent substrate (a triacetyl cellulose resin film (TF 80UL, produced by FUJIFILM Corp.) having a thickness of 80 μm) was prepared, the hard coat layer-forming composition 7 was applied onto one side of the film, and the applied composition on the film was dried for 60 seconds in a hot oven of 50° C. to evaporate the solvent in a coat. Then, the coat was cured by irradiating ultraviolet light to the coat in such a way that an accumulated light quantity is 50 mJ to form an antistatic hard coat layer of 3.0 g/cm² (as a dried film thickness).

Next, the following over coating formulation C was applied onto the above-mentioned antistatic hard coat layer, and then the applied formulation C on the hard coat layer was dried for 60 seconds in a hot oven of 50° C. to evaporate the solvent in a coat, and then the coat was cured by irradiating ultraviolet light to the coat in such a way that an accumulated light quantity is 50 mJ to form an over coating layer of 7.0 g/cm² (as a dried film thickness) to prepare an optical layered body.

### PRODUCTION EXAMPLE

### Over Coating (Antiglare Layer) Formulation C

| | | |
|---|---|---|
| Polymer acrylate (Beamset BS371; produced by | 4 | parts by weight |
| Arakawa Chemical Industries, Ltd., weight | | |
| average molecular weight 20000) | | |
| Pentaerithritol triacrylate (PETA; produced by | 6 | parts by weight |
| Nippon Kayaku Co., Ltd.) | | |
| Acrylic-styrene bead (SSX-42CSS; produced by | 0.8 | parts by weight |
| SEKISUI PLASTICS Co., Ltd., average particle | | |
| diameter 3.5 μm, refractive index 1.55) | | |
| Polymerization initiator (Irgacure 184; produced | 0.66 | parts by weight |
| by Ciba Specialty Chemicals K.K.) | | |
| Polymerization initiator (Irgacure 907; produced | 0.11 | parts by weight |
| by Ciba Specialty Chemicals K.K.) | | |
| Polyether modified silicone oil (10% solution | 0.005 | parts by weight |
| diluted with toluene; produced by Shin-Etsu | | |
| Chemical Co., Ltd.) | | |
| Toluene | 15.9 | parts by weight |
| Cyclohexanone | 7.6 | parts by weight |
| Methyl isobutyl ketone | 1.8 | parts by weight |

### EXAMPLE 15

An optical layered body was produced by the same procedure as in Example 14 except for using the hard coat layer-forming composition 8 in place of the hard coat layer-forming composition 7.

### EXAMPLE 16

A transparent substrate (a triacetyl cellulose resin film (TF 80UL, produced by FUJIFILM Corp.) having a thickness of 80 μm) was prepared, the hard coat layer-forming composition 9 was applied onto one side of the film, and the applied composition on the film was dried for 60 seconds in a hot oven of 50° C. to evaporate the solvent in a coat, and then the coat was cured by irradiating ultraviolet light to the coat in such a way that an accumulated light quantity is 50 mJ to form an antistatic hard coat layer of 3.5 g/cm² (as a dried film thickness).

Next, the following over coating formulation D was applied onto the above-mentioned antistatic hard coat layer, and then the applied formulation D on the hard coat layer was dried for 60 seconds in a hot oven of 50° C. to evaporate the solvent in a coat, and then the coat was cured by irradiating ultraviolet light to the coat in such a way that an accumulated light quantity is 50 mJ to form an over coating layer of 4.0 g/cm² (as a dried film thickness) to prepare an optical layered body.

### PRODUCTION EXAMPLE

### Over Coating (Clear Layer) Formulation D

| | | |
|---|---|---|
| Urethane acrylate (UV-1700B; produced by | 5.0 | parts by weight |
| Nippon Synthetic Chemical Industry Co., Ltd., | | |
| decafunctional, weight average molecular weight | | |
| 2000) | | |
| Polymer acrylate (Beamset BS371; produced by | 5.0 | parts by weight |
| Arakawa Chemical Industries, Ltd., weight | | |
| average molecular weight 20000) | | |
| Polymerization initiator (Irgacure 184; produced | 0.60 | parts by weight |
| by Ciba Specialty Chemicals K.K.) | | |
| Polymerization initiator (Irgacure 907; produced | 0.100 | parts by weight |
| by Ciba Specialty Chemicals K.K.) | | |
| Polyether modified silicone oil (10% solution | 0.002 | parts by weight |
| diluted with toluene; produced by Shin-Etsu | | |
| Chemical Co., Ltd.) | | |
| Toluene | 9.3 | parts by weight |
| Cyclohexanone | 5.6 | parts by weight |
| Methyl isobutyl ketone | 3.7 | parts by weight |

### EXAMPLE 17

An optical layered body was produced by the same procedure as in Example 16 except for using the hard coat layer-forming composition 10 in place of the hard coat layer-forming composition 9.

### EXAMPLE 18

A transparent substrate (a triacetyl cellulose resin film (TF 80UL, produced by FUJIFILM Corp.) having a thickness of 80 μm) was prepared, the hard coat layer-forming composition 11 was applied onto one side of the film, and the applied composition on the film was dried for 60 seconds in a hot oven of 50° C. to evaporate the solvent in a coat, and then the coat was cured by irradiating ultraviolet light to the coat in such a way that an accumulated light quantity is 50 mJ to form an antistatic hard coat layer of 3.5 g/cm² (as a dried film thickness).

Next, an over coating was formed on the above-mentioned antistatic hard coat layer using the over coating formulation B in the same manner as in Example 13 to prepare an optical layered body.

### EXAMPLE 19

An optical layered body was produced by the same procedure as in Example 14 except for using the hard coat layer-forming composition 12 in place of the hard coat layer-forming composition 7.

### EXAMPLE 20

A transparent substrate (a triacetyl cellulose resin film (TF 80UL, produced by FUJIFILM Corp.) having a thickness of 80 μm) was prepared, the hard coat layer-forming composition 13 was applied onto one side of the film, and the applied composition on the film was dried for 60 seconds in a hot oven of 50° C. to evaporate the solvent in a coat, and then the coat was cured by irradiating ultraviolet light to the coat in such a way that an accumulated light quantity is 50 mJ to form an antistatic hard coat layer of 15 g/cm² (as a dried film thickness) to prepare an optical layered body.

### EXAMPLE 21

An optical layered body was produced by the same procedure as in Example 20 except for using the hard coat layer-forming composition 20 in place of the hard coat layer-forming composition 13.

### EXAMPLE 22

A transparent substrate (a triacetyl cellulose resin film (TF 80UL, produced by FUJIFILM Corp.) having a thickness of 80 μm) was prepared, the hard coat layer-forming composition 1 was applied onto one side of the film, and the applied composition on the film was dried for 60 seconds in a hot oven of 50° C. to evaporate the solvent in a coat, and then the coat was half-cured by irradiating ultraviolet light to the coat in such a way that an accumulated light quantity is 20 mJ to form an antistatic hard coat layer of 15 g/cm² (as a dried film thickness) to prepare an optical layered body.

Furthermore, the following low refractive index layer-forming composition 1 was applied onto the above-mentioned antistatic hard coat layer so as to be 100 nm in thickness, and the applied composition on the hard coat layer was dried for 60 seconds in a hot oven of 50° C. to evaporate the solvent in a coat, and then the coat was cured by irradiating ultraviolet light to the coat in such a way that an accumulated light quantity is 100 mJ to prepare an antireflection optical layered body.

### <Production Example Low Refractive Index Layer-Forming Composition 1

Hollow treated silica fine particle (A solid content of the silica fine particle is 200 by weight of a solution; methyl isobutyl ketone, particle diameter 50 nm) 73 parts by weight Pentaerithritol triacrylate (PETA) 10 parts by weight Polymerization initiator (Irgacure 127; produced by Ciba Specialty Chemicals K.K.) 0.35 parts by weight Silicone oil (X-22-164E; produced by Shin-Etsu Chemical Co., Ltd.) 1 part by weight

Methyl isobutyl ketone 320 parts by weight
Propylene glycol monomethyl ether (PGME) 161 parts by weight

### EXAMPLES 23 AND 24

Optical layered bodies were produced by the same procedure as in Example 22 except for using the hard coat layer-forming composition 21 or 22 in place of the hard coat layer-forming composition 1.

### COMPARATIVE EXAMPLES 1 TO 5

Optical layered bodies were produced by the same procedure as in Example 1 except for using the hard coat layer-forming compositions 14 to 18 in place of the hard coat layer-forming composition 1.

### COMPARATIVE EXAMPLE 6

An optical layered body was produced by the same procedure as in Example 14 except for using the hard coat layer-forming composition 19 in place of the hard coat layer-forming composition 7.

The optical layered bodies obtained in Examples and Comparative Examples were evaluated by the following methods. The results of evaluations are shown in Table 1.

### (Evaluation 1: Surface Resistivity)

A surface resistivity (Ω/square) was measured at an applied voltage of 1000 V with a surface resistivity meter (manufactured by Mitsubishi Chemical Corp., trade no.; Hiresta IP MCP-HT260).

### (Evaluation 2: Saturated Charged Voltage)

The saturated charged voltage was measured according to JIS L 1094 under the conditions of applied voltage 10 kV, distance 20 mm, temperature 25° C. and humidity 40% RH using STATIC HONESTMETER H-0110 (manufactured by SHISHIDO ELECTROSTATIC, Ltd.).

In addition, when the saturated charged voltage is 1 or less, the optical layered body can be used effectively particularly in an IPA mode which is susceptible to surface charge.

### (Evaluation 3: Presence or Absence of Generation of Interference Fringe)

A black tape for preventing back reflection was stuck on the surface opposite to the hard coat layer side of the optical layered body, and the optical layered body was visually observed from a hard coat layer side to check the presence or absence of generation of the interference fringe. In the observation results, the case where the interference fringe was not generated was denoted by “none” and the case where the interference fringe was generated was denoted by “present”.

### (Evaluation 4: Scratch Hardness Test by Pencil Method)

Scratch hardness test by pencil method; After the prepared hard coat film (the optical layered body described above) was subjected to humidity conditioning for 2 hours under the conditions of temperature 25° C. and humidity 60% RH, the hardness of a scratch test by a pencil method was performed at a load of 4.9 N according to a pencil hardness evaluation method specified by JIS K 5600-5-4 (1999) using a test pencil (hardness class H to class 3H) specified by JIS S 6006.

### (Evaluation 5: Steel Wool Resistance

The outermost surface of the optical layered body was rubbed back and forth 10 times at a prescribed friction load (load was changed 200 g by 200 g from 200 g to 1200 g) using steel wool of #0000, and thereafter the presence or absence of a surface flaw of the rubbed coat was visually examined under a fluorescent lamp and rated according to the following criteria.

### Evaluation Criteria

excellent: There was no flaw on the coat at a load of 1200 g.
good: There was no flaw on the coat at a load of 800 g.
poor: There were flaws on the coat at a load of 800 g.

### (Evaluation 6: Degree of Coat Adhesion)

The degree of coat adhesion was evaluated by a cross-cut test. Number of cut portions formed by cutting slits remaining on the substrate after peeling off an adhesive tape per one hundred of cut portions formed by cutting slits was counted. In addition, if the number of cut portions remaining was one hundred, it was considered as acceptance, and it was rejected if not all of cut portions remain. Further, if there is a minute chip at a cut edge, but not reaching one peeling, the chip is referred to as a “chip of edge”, and considered as rejection.

### (Evaluation 7: Total Light Transmittance)

A total light transmittance (%) was measured according to JIS K 7361 using a haze meter (manufactured by Murakami Color Research Laboratory Co., Ltd., trade no.; HM-150). The case where the total light transmittance is 900 or more was considered as good.

### (Evaluation 8: Haze Value)

Haze value (%) was measured according to JIS K 7136 using a haze meter (manufactured by Murakami Color Research Laboratory Co., Ltd., trade no.; HM-150).

When the optical layered body did not have an antiglare property, the optical layered body in which a haze value was less than 0.5% was considered as good. When the optical layered body had an antiglare property, haze values were all good because materials in which haze values were less than 0.5% were selected first as a material of a resin composition before an antiglare material was added, and by use of these materials, the optical layered bodies for Examples and Comparative Examples were prepared.

TABLE 1

| | Surface | Saturated | | Scratch hardness | Steel wool | Degree | Degree | Total light | | Application | |
|---|---|---|---|---|---|---|---|---|---|---|---|
| | resistivity | charge | Interference | (by a pencil | abrasion | of coat | of coat | transmittance | | amount | |
| | (Ω/square) | voltage (kV) | fringe | method) | resistance | adhesion 1 | adhesion 2 | (%) | Haze (%) | (g/m²) | |
| Example1 | 10⁹ | 0.5 | none | 3H | excellent | 100 | — | 92 | 0.3 | 15.0 | |
| Example2 | 10¹⁰ | 0.5 | none | 3H | excellent | 100 | — | 92 | 0.3 | 15.0 | |
| Example3 | 10⁹ | 0.5 | none | 3H | excellent | 100 | — | 92 | 0.3 | 15.0 | |
| Example4 | 10⁹ | 0.5 | none | 3H | excellent | 100 | — | 92 | 0.3 | 15.0 | |
| Example5 | 10⁹ | 0.5 | none | 3H | excellent | 100 | — | 92 | 0.3 | 15.0 | |
| Example6 | 10⁹ | 0.5 | none | 3H | excellent | 100 | — | 92 | 0.3 | 15.0 | |
| Example7 | 10⁹ | 0.5 | none | 2H | good | 100 | — | 92 | 0.3 | 3.0 | |
| Example8 | 10⁹ | 0.5 | none | 3H | good | 100 | — | 92 | 0.3 | 3.0 | |
| Example9 | 10⁹ | 0.5 | none | 2H | good | 100 | — | 90 | 55.0 | 3.5 | |
| Example10 | 10⁹ | 0.5 | none | 3H | excellent | 100 | — | 90 | 55.0 | 3.5 | |
| Example11 | 10⁹ | 0.5 | none | 3H | excellent | 100 | — | 92 | 2.0 | 3.5 | |
| Example12 | 10⁹ | 0.5 | none | 3H | excellent | 100 | — | 92 | 0.3 | 15.0 | 0.2 |
| Example13 | 10⁹ | 0.5 | none | 3H | excellent | 100 | — | 93 | 0.3 | 15.0 | 0.2 |
| Example14 | ND | 1 | none | 2H | good | 100 | — | 92 | 7.0 | 3.0 | 7.0 |
| Example15 | ND | 1 | none | 3H | good | 100 | — | 92 | 7.0 | 3.0 | 7.0 |
| Example16 | ND | 0.5 | none | 2H | good | 100 | — | 92 | 6.0 | 3.5 | 4.0 |
| Example17 | ND | 0.5 | none | 3H | excellent | 100 | — | 92 | 6.0 | 3.5 | 4.0 |
| Example18 | 10⁹ | 0.5 | none | 3H | excellent | 100 | — | 93 | 2.0 | 3.5 | 0.2 |
| Example19 | ND | 1 | none | 2H | good | 100 | — | 92 | 7.0 | 3.0 | 7.0 |
| Example20 | 10⁹ | 0.5 | none | 3H | excellent | 100 | — | 92 | 0.3 | 15.0 | |
| Example21 | 10⁹ | 0.5 | none | 2H | good | 100 | — | 92 | 0.3 | 15.0 | |
| Example22 | 10⁹ | 0.5 | none | 3H | excellent | 100 | 100 | 95 | 0.3 | 15.0 | 0.2 |
| Example23 | 10⁹ | 0.5 | none | H | good | 100 | 95 | 95 | 0.2 | 15.0 | 0.2 |
| Example24 | 10⁹ | 0.5 | none | 2H | good | 100 | 50 | 95 | 0.2 | 15.0 | 0.2 |
| Comparative | 10⁹ | 0.5 | none | H | poor | 100 | — | 92 | 0.3 | 15.0 | |
| Example1 | | | | | | | | | | | |
| Comparative | 10⁹ | 0.5 | present | 3H | excellent | 100 | — | 92 | 0.3 | 15.0 | |
| Example2 | | | | | | | | | | | |
| Comparative | 10⁹ | 0.5 | present | H | poor | 100 | — | 92 | 0.3 | 15.0 | |
| Example3 | | | | | | | | | | | |
| Comparative | ND | 2 | none | 3H | excellent | 100 | — | 92 | 0.3 | 15.0 | |
| Example4 | | | | | | | | | | | |
| Comparative | 10⁷ | 0.5 | none | 3H | excellent | 100 | — | 85 | 1.5 | 15.0 | |
| Example5 | | | | | | | | | | | |
| Comparative | ND | 1 | none | 2H | good | Chip of | — | 92 | 7.0 | 0.3 | 7.0 |
| Example6 | | | | | | edge | | | | | |

ND indicates an evaluation item which could not be measured due to an overrange of an instrument.
With respect to the application amounts of Examples 12 to 19 and 22 to 24 and Comparative Example 6, a value in a left section indicates an application amount of the hard coat layer and a value in a right section indicates an application amount of the over coating.
Degree of coat adhesion 1 indicates a degree of adhesion at an interface between the substrate and the hard coat (HC) layer. When the over coating layer is formed, it indicates a degree of adhesion at an interface between the HC layer and the over coating layer.
Degree of coat adhesion 2 indicates a degree of adhesion at an interface between the HC layer and the low refractive index layer.

It is shown from Table 1 that the optical layered bodies of Examples did not generate interference fringes and were superior in all antistatic performance, hardness and optical properties (a light transmittance and haze). On the other hand, there was no optical layered body of Comparative Examples which was superior in all the above-mentioned evaluation items.

### EXAMPLES 25 TO 35, COMPARATIVE EXAMPLES 7 TO 13

Antistatic layer-forming compositions 1 to 5 and hard coat layer-forming compositions 23 to 32 were prepared based on the composition shown in Production Examples 23 to 37 below.

### PRODUCTION EXAMPLE 23

### Antistatic Layer-Forming Composition 1

| | | |
|---|---|---|
| Antistatic agent (ATO dispersant, produced by | 9.5 | parts by weight |
| The Inctec Inc., trade name; ASHD300S, solid | | |
| content 42%, PV300) | | |
| Pentaerithritol triacrylate (produced by | 0.05 | parts by weight |
| Nippon Kayaku Co., Ltd.; PET-30) | | |
| Cyclohexanone | 45 | parts by weight |
| Polymerization initiator (produced by Ciba | 0.15 | parts by weight |
| Specialty Chemicals K.K., trade name; | | |
| Irgacure 184) | | |

### PRODUCTION EXAMPLE 24

### Antistatic layer-forming composition

| | | |
|---|---|---|
| Antistatic agent (ATO dispersant, produced by | 9.5 | parts by weight |
| The Inctec Inc., trade name; ASHD300S, solid | | |
| content 42%, PV300) | | |
| Pentaerithritol triacrylate (produced by | 0.5 | parts by weight |
| Nippon Kayaku Co., Ltd.; PET-30) | | |
| Cyclohexanone | 45 | parts by weight |
| Polymerization initiator (produced by Ciba | 0.15 | parts by weight |
| Specialty Chemicals K.K., trade name; | | |
| Irgacure 184) | | |

### PRODUCTION EXAMPLE 25

### Antistatic Layer-Forming Composition 3

| | | |
|---|---|---|
| Antistatic agent (a polythiophene dispersion, | 3 | parts by weight |
| TA2010 produced by Idemitsu Technofine Co., | | (on the solid |
| Ltd.) | | content 100% |
| | | equivalent basis) |
| Pentaerithritol triacrylate (produced by Nippon | 1 | part by weight |
| Kayaku Co., Ltd.; PET-30) | | |
| Isopropyl alcohol | 50 | parts by weight |
| Ethanol | 50 | parts by weight |
| Polymerization initiator (produced by Ciba | 0.02 | parts by weight |
| Specialty Chemicals K.K., trade name; | | |
| Irgacure 184) | | |

### PRODUCTION EXAMPLE 26

### Antistatic Layer-Forming Composition 4

| | | |
|---|---|---|
| Antistatic agent (a zinc antimonate dispersion, | 10 | parts by weight |
| 60% methanol sol of dispersed ZnSb₂O₆, | | |
| produced by Nissan Chemical Industries, Ltd., | | |
| CELNAX CX-Z693-F) | | |
| Pentaerithritol triacrylate (produced by Nippon | 18 | parts by weight |
| Kayaku Co., Ltd.; PET-30) | | |
| Methanol | 450 | parts by weight |
| Polymerization initiator (produced by Ciba | 0.7 | parts by weight |
| Specialty Chemicals K.K., trade name; | | |
| Irgacure 184) | | |

### PRODUCTION EXAMPLE 27

### Antistatic Layer-Forming Composition 5

| | | |
|---|---|---|
| Pentaerithritol triacrylate (produced by Nippon | 20 | parts by weight |
| Kayaku Co., Ltd.; PET-30) | | |
| Methanol | 450 | parts by weight |
| Polymerization initiator (produced by Ciba | 0.7 | parts by weight |
| Specialty Chemicals K.K., trade name; | | |
| Irgacure 184) | | |

### PRODUCTION EXAMPLE 28

### Hard Coat Layer-Forming Composition 23

| | | |
|---|---|---|
| Urethane acrylate (UV-1700B; produced by | 49 | parts by weight |
| Nippon Synthetic Chemical Industry Co., Ltd., | | |
| decafunctional, weight average molecular | | |
| weight 2000) | | |
| Polyester triacrylate (M-9050; produced by | 49 | parts by weight |
| TOAGOSEI Co., Ltd., trifunctional, | | |
| weight average molecular weight 418) | | |
| Antistatic agent (H6100; produced by Mitsubishi | 2 | parts by weight |
| Chemical Corp., weight average molecular weight | | |
| 1500, solid content 50%, A content of quaternary | | |
| ammonium salt component is 21% in a solid | | |
| content) | | |
| Polymerization initiator (Irgacure 184; produced | 4 | parts by weight |
| by Ciba Specialty Chemicals K.K.) | | |
| Methyl ethyl ketone | 100 | parts by weight |

(* A quaternary ammonium salt component exists in an amount of 0.20% in a solid content)

### PRODUCTION EXAMPLE 29

### Hard Coat Layer-Forming Composition 24

| | |
|---|---|
| Urethane acrylate (UV-1700B; produced by | 40 parts by weight |
| Nippon Synthetic Chemical Industry Co., Ltd., | |
| decafunctional, weight average molecular | |
| weight 2000) | |
| Polyester triacrylate (M-9050; produced by | 40 parts by weight |
| TOAGOSEI Co., Ltd., trifunctional, | |
| weight average molecular weight 418) | |
| Antistatic agent (H6100; produced by Mitsubishi | 20 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 4 parts by weight |
| by Ciba Specialty Chemicals K.K.) | |
| Methyl ethyl ketone | 100 parts by weight |

(* A quaternary ammonium salt component exists in an amount of 2.23% in a solid content)

### PRODUCTION EXAMPLE 30

### Hard Coat Layer-Forming Composition 25

| | |
|---|---|
| Urethane acrylate (UV-1700B; produced by | 30 parts by weight |
| Nippon Synthetic Chemical Industry Co., Ltd., | |
| decafunctional, weight average molecular | |
| weight 2000) | |
| Polyester triacrylate (M-9050; produced by | 30 parts by weight |
| TOAGOSEI Co., Ltd., trifunctional, | |
| weight average molecular weight 418) | |
| Antistatic agent (H6100; produced by Mitsubishi | 40 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 4 parts by weight |
| by Ciba Specialty Chemicals K.K.) | |
| Methyl ethyl ketone | 100 parts by weight |

(* A quaternary ammonium salt component exists in an amount of 5.00% in a solid content)

### PRODUCTION EXAMPLE 31

### Hard Coat Layer-Forming Composition 26

| | |
|---|---|
| Urethane acrylate (UV-1700B; produced by | 49 parts by weight |
| Nippon Synthetic Chemical Industry Co., Ltd., | |
| decafunctional, weight average molecular | |
| weight 2000) | |
| Polyester triacrylate (M-9050; produced by | 49 parts by weight |
| TOAGOSEI Co., Ltd., trifunctional, | |
| weight average molecular weight 418) | |
| Antistatic agent (H6100; produced by Mitsubishi | 2 parts by weight |
| Chemical Corp., weight average molecular weight | |
| 1500, solid content 50%, A content of quaternary | |
| ammonium salt component is 21% in a solid | |
| content) | |
| Polymerization initiator (Irgacure 184; produced | 4 parts by weight |
| by Ciba Specialty Chemicals K.K.) | |
| Methyl acetate | 100 parts by weight |

(* A quaternary ammonium salt component exists in an amount of 0.20% in a solid content)

### PRODUCTION EXAMPLE 32

### Hard Coat Layer-Forming Composition 27

| | |
|---|---|
| Urethane acrylate (BS 577; produced by Arakawa Chemical | 49 parts by weight |
| Industries, Ltd., hexafunctional, weight average molecular | |
| weight 1000) | |
| Pentaerithritol triacrylate (PET30; produced by Nippon Kayaku | 49 parts by weight |
| Co., Ltd., trifunctional, weight average molecular weight 298) | |
| Antistatic agent (H6100; produced by Mitsubishi Chemical Corp., | 2 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 4 parts by weight |
| Specialty Chemicals K.K.) | |
| Methyl ethyl ketone | 100 parts by weight |

(* A quaternary ammonium salt component exists in an amount of 0.20% in a solid content)

### PRODUCTION EXAMPLE 33

### Hard Coat Layer-Forming Composition 28

| | |
|---|---|
| Urethane acrylate (Artresin UN-3320HSBA; produced by Negami | 49 parts by weight |
| Chemical Industrial Co., Ltd., pentadecafunctional, weight | |
| average molecular weight 5000) | |
| Isocyanuric acid modified triacrylate (M-315; produced by | 49 parts by weight |
| Toagosei Co., Ltd., trifunctional, weight average molecular | |
| weight 423) | |
| Antistatic agent (H6100; produced by Mitsubishi Chemical Corp., | 2 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 4 parts by weight |
| Specialty Chemicals K.K.) | |
| Methyl ethyl ketone | 100 parts by weight |

(* A quaternary ammonium salt component exists in an amount of 0.20% in a solid content)

### PRODUCTION EXAMPLE 34

### Hard Coat Layer-Forming Composition 29

| | |
|---|---|
| Urethane acrylate (UV-1700B; produced by Nippon Synthetic | 50 parts by weight |
| Chemical Industry Co., Ltd., decafunctional, weight average | |
| molecular weight 2000) | |
| Polyester triacrylate (M-9050; produced by TOAGOSEI Co., Ltd., | 50 parts by weight |
| trifunctional, weight average molecular weight 428) | |
| Antistatic agent (H6100; produced by Mitsubishi Chemical Corp., | 0.2 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 4 parts by weight |
| Specialty Chemicals K.K.) | |
| Methyl ethyl ketone | 100 parts by weight |

(* A quaternary ammonium salt component exists in an amount of 0.02% in a solid content)

### PRODUCTION EXAMPLE 35

### Hard Coat Layer-Forming Composition 30

| | |
|---|---|
| Urethane acrylate (UV-1700B; produced by Nippon Synthetic | 50 parts by weight |
| Chemical Industry Co., Ltd., decafunctional, weight average | |
| molecular weight 2000) | |
| Polyester triacrylate (M-9050; produced by TOAGOSEI Co., Ltd., | 50 parts by weight |
| trifunctional, weight average molecular weight 428) | |
| Polymerization initiator (Irgacure 184; produced by Ciba | 4 parts by weight |
| Specialty Chemicals K.K.) | |
| Methyl ethyl ketone | 100 parts by weight |

(* A quaternary ammonium salt component does not exist in a solid content)

### PRODUCTION EXAMPLE 36

### Hard Coat Layer-Forming Composition 31

| | |
|---|---|
| Urethane acrylate (UV-1700B; produced by Nippon Synthetic | 30 parts by weight |
| Chemical Industry Co., Ltd., decafunctional, weight average | |
| molecular weight 2000) | |
| Polyester triacrylate (M-9050; produced by TOAGOSEI Co., Ltd., | 30 parts by weight |
| trifunctional, weight average molecular weight 428) | |
| Antistatic agent (H6100; produced by Mitsubishi Chemical Corp., | 40 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 4 parts by weight |
| Specialty Chemicals K.K.) | |
| Toluene | 100 parts by weight |

(* A quaternary ammonium salt component exists in an amount of 5.00% in a solid content)

### PRODUCTION EXAMPLE 37

### Hard Coat Layer-Forming Composition 32

| | |
|---|---|
| Urethane acrylate (UV-2000B; produced by Nippon Synthetic | 49 parts by weight |
| Chemical Industry Co., Ltd., difunctional, weight average | |
| molecular weight 13000) | |
| Lauryl acrylate (LIGHT-ACRYLATE; produced by KYOEISHA CHEMICAL | 49 parts by weight |
| Co., Ltd., monofunctional, weight average molecular weight 240) | |
| Antistatic agent (H6100; produced by Mitsubishi Chemical Corp., | 2 parts by weight |
| weight average molecular weight 1500, solid content 50%, A | |
| content of quaternary ammonium salt component is 21% in a solid | |
| content) | |
| Polymerization initiator (Irgacure 184; produced by Ciba | 4 parts by weight |
| Specialty Chemicals K.K.) | |
| Methyl ethyl ketone | 100 parts by weight |

(* A quaternary ammonium salt component exists in an amount of 0.20% in a solid content)

### EXAMPLE 25

### Production of Optical Layered Body

A transparent substrate (a triacetyl cellulose resin film (TF 80UL, produced by FUJIFILM Corp.) having a thickness of 80 μm) was prepared, the antistatic layer-forming composition 1 was applied onto one side of the film, and the applied composition on the film was dried for 60 seconds in a hot oven of 70° C. to evaporate the solvent in a coat, and then the coat was cured by irradiating ultraviolet light to the coat in such a way that an accumulated light quantity is 50 mJ to form an antistatic layer of 1 g/cm² (as a dried film thickness). Next, the hard coat layer-forming composition 23 was applied onto the obtained antistatic layer, and then the applied composition 23 on the antistatic layer was dried in the same manner as in forming the antistatic layer, and then the resulting coat was cured by irradiating ultraviolet light to the coat in such a way that an accumulated light quantity is 150 mJ to form a hard coat layer of 15 g/cm² (as a dried film thickness), and thereby, an optical layered body including a light-transmitting substrate, an antistatic layer and a hard coat layer in order was prepared.

### EXAMPLES 26 TO 34, COMPARATIVE EXAMPLES 7 TO 13

Optical layered bodies were produced by the same procedure as in Example 25 except for using antistatic layer-forming compositions and hard coat layer-forming compositions shown in Table 2 in place of the antistatic layer-forming composition 1 and the hard coat layer-forming composition 23 in Example 25.

### EXAMPLE 35

A transparent substrate (a triacetyl cellulose resin film (TF 80UL, produced by FUJIFILM Corp.) having a thickness of 80 μm) was prepared, the hard coat layer-forming composition 24 was applied onto one side of the film, and the applied composition on the film was dried for 60 seconds in a hot oven of 70° C. to evaporate the solvent in a coat, and then the coat was cured by irradiating ultraviolet light to the coat in such a way that an accumulated light quantity is 150 mJ to form a hard coat layer of 15 g/cm² (as a dried film thickness). Next, the antistatic layer-forming composition 2 was applied onto the obtained hard coat layer, and then the applied composition 2 on the hard coat layer was dried in the same manner as in forming the hard coat layer, and then the resulting coat was cured by irradiating ultraviolet light to the coat in such a way that an accumulated light quantity is 50 mJ to form an antistatic layer of 1 g/cm² (as a dried film thickness), and thereby, an optical layered body including a light-transmitting substrate, a hard coat layer and an antistatic layer in order was prepared.

The optical layered bodies obtained in Examples 25 to 35 and Comparative Examples 7 to 13 were evaluated by the following methods. The results of evaluations are shown in Table 2.

### (Evaluation 1: Surface Resistivity)

A surface resistivity (Ω/square) was measured at an applied voltage of 1000 V with a surface resistivity meter (manufactured by Mitsubishi Chemical Corp., trade no.; Hiresta IP MCP-HT260).

### (Evaluation 2: Saturated Charged Voltage)

The saturated charged voltage was measured according to JIS L 1094 under the conditions of applied voltage 10 kV, distance 20 mm, temperature 25° C. and humidity 40% RH using STATIC HONESTMETER H-0110 (manufactured by SHISHIDO ELECTROSTATIC, Ltd.).

In addition, when the saturated charged voltage is 1 or less, the optical layered body can be used effectively particularly in an IPA mode which is susceptible to surface charge.

### (Evaluation 3: Presence or Absence of Generation of Interference Fringe)

A black tape for preventing back reflection was stuck on the surface opposite to the hard coat layer side of the optical layered body, and the optical layered body was visually observed from a hard coat layer side to check the presence or absence of generation of the interference fringe. In the observation results, the case where the interference fringe was not generated was denoted by “none” and the case where the interference fringe was generated was denoted by “present”.

### (Evaluation 4: Degree of Coat Adhesion)

The degree of coat adhesion was evaluated by a cross-cut test. Number of cut portions formed by cutting slits remaining on the substrate after peeling off an adhesive tape per one hundred of cut portions formed by cutting slits was counted. In addition, when the number of cut portions remaining was one hundred, it was considered as acceptance, and it was rejected if not all of cut portions remain. Further, if there is a minute chip at a cut edge, but not reaching one peeling, the chip is referred to as a “chip of edge”, and considered as rejection.

### (Evaluation 5: Scratch Hardness Test by Pencil Method)

Scratch hardness test by pencil method; After the prepared hard coat film (the optical layered body described above) was subjected to humidity conditioning for 2 hours under the conditions of temperature 25° C. and humidity 60% RH, the hardness of a scratch test by a pencil method was performed at a load of 4.9 N according to a pencil hardness evaluation method specified by JIS K5600-5-4 (1999) using a test pencil (hardness class H to class 3H) specified by JIS S 6006.

TABLE 2

| | Antistatic layer | | | Hard coat layer | | | Optical layered body | | | | |
|---|---|---|---|---|---|---|---|---|---|---|---|
| | | | Surface | | Quaternary | | Surface | Saturated | Interfer- | | |
| | Compo- | Antistatic | resistivity | | ammonium salt | | resistivity | charge | ence | Adhe- | |
| | sition | agent | (Ω/square) | Composition | (content %) | Solvent | (Ω/square) | voltage (kV) | fringe | sion | Hardness |
| Example25 | 1 | ATO | 10⁶ | 23 | 0.20 | MEK | 10¹⁰ | 0.5 | none | 100 | 3H |
| Example26 | 1 | ATO | 10⁶ | 24 | 2.23 | MEK | 10⁹ | 0.5 | none | 100 | 3H |
| Example27 | 1 | ATO | 10⁶ | 25 | 5.00 | MEK | 10⁸ | 0.5 | none | 100 | 3H |
| Example28 | 2 | ATO | 10⁸ | 24 | 2.23 | MEK | 10⁹ | 0.5 | none | 100 | 3H |
| Example29 | 3 | polythiophene | 10⁶ | 24 | 2.23 | MEK | 10¹⁰ | 0.5 | none | 100 | 3H |
| Example30 | 4 | antimonic acid | 10⁸ | 24 | 2.23 | MEK | 10⁹ | 0.5 | none | 100 | 3H |
| Example31 | 1 | ATO | 10⁶ | 26 | 0.20 | methyl | 10¹⁰ | 0.5 | none | 100 | 3H |
| | | | | | | acetate | | | | | |
| Example32 | 1 | ATO | 10⁶ | 27 | 0.20 | MEK | 10¹⁰ | 0.5 | none | 100 | 3H |
| Example33 | 1 | ATO | 10⁶ | 28 | 0.20 | MEK | 10¹⁰ | 0.5 | none | 100 | 3H |
| Example34 | 2 | ATO | 10⁸ | 24 | 2.23 | MEK | 10⁸ | 0.5 | none | 100 | 3H |
| Example35 | 2 | ATO | 10⁸ | 24 | 2.23 | MEK | 10⁹ | 0.5 | none | 100 | 3H |
| Comparative | 5 | none | ND | 23 | 0.20 | MEK | ND | 2 | none | 100 | 3H |
| Example7 | | | | | | | | | | | |
| Comparative | 1 | ATO | 10⁶ | 29 | 0.02 | MEK | ND | 2 | none | 100 | 3H |
| Example8 | | | | | | | | | | | |
| Comparative | 3 | polythiophene | 10⁶ | 29 | 0.02 | MEK | ND | 2 | none | 100 | 3H |
| Example9 | | | | | | | | | | | |
| Comparative | 5 | none | ND | 30 | 0.00 | MEK | ND | 2 | none | 100 | 3H |
| Example10 | | | | | | | | | | | |
| Comparative | 1 | ATO | 10⁶ | 30 | 0.00 | MEK | ND | 2 | none | 100 | 3H |
| Example11 | | | | | | | | | | | |
| Comparative | 1 | ATO | 10⁶ | 31 | 5.00 | toluene | 10¹⁰ | 0.5 | present | 0 | 3H |
| Example12 | | | | | | | | | | | |
| Comparative | 1 | ATO | 10⁶ | 32 | 0.20 | MEK | 10¹⁰ | 0.5 | none | 50 | 3H |
| Example13 | | | | | | | | | | | |

The optical layered body in Example 35 is composed of a substrate, a hard coat layer and an antistatic layer in this order.
ND indicates an evaluation item which could not be measured due to an overrange of an instrument.

It is shown from Table 2 that the optical layered bodies of Examples had good antistatic performance and did not generate interference fringes, and were superior in all adhesion and hardness. On the other hand, there was no optical layered body of Comparative Examples which was superior in all these evaluation items.

### INDUSTRIAL APPLICABILITY

The optical layered body of the present invention can be suitably applied to cathode ray tube (CRT) display devices, liquid crystal displays (LCD), plasma displays (PDP), electroluminescence displays (ELD), and field emission displays (FED).

1. An optical layered body comprising a light-transmitting substrate and a hard coat layer formed on the light-transmitting substrate,
wherein the hard coat layer is a resin layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent; and
a content of the quaternary ammonium salt in the hard coat layer is 0.5 to 18% by weight.

2. An optical layered body comprising a light-transmitting substrate, an antistatic layer and a hard coat layer,
wherein the hard coat layer is a resin layer formed from a hard coat layer-forming composition containing a quaternary ammonium salt having a weight average molecular weight of 1000 to 50000, a tri- or morefunctional (meth)acrylate compound having a weight average molecular weight of 700 or less, and a permeable solvent; and
a content of the quaternary ammonium salt in the hard coat layer is 0.1 to 10% by weight.

3. The optical layered body according to claim 1, wherein the quaternary ammonium salt is a compound having a photoreactive unsaturated bond.

4. The optical layered body according to claim 1, wherein the hard coat layer-forming composition further contains a hexa- or morefunctional (meth)acrylate compound having a weight average molecular weight of 1000 or more.

5. The optical layered body according to claim 4,
wherein the hexa- or morefunctional (meth)acrylate compound having a weight average molecular weight of 1000 or more is a urethane (meth)acrylate compound.

6. The optical layered body according to claim 5,
wherein a mixing ratio of the hexa- or morefunctional urethane (meth)acrylate compound having a weight average molecular weight of 1000 or more to the tri- or morefunctional (meth)acrylate compound having a weight average molecular weight of 700 or less is 5/95 to 90/10 in terms of solid weight ratio.

7. The optical layered body according to claim 1, wherein the light-transmitting substrate is made from triacetyl cellulose.

8. The optical layered body according to claim 1, wherein the permeable solvent is at least one selected from the group consisting of methyl acetate, ethyl acetate, butyl acetate, methyl ethyl ketone, methyl isobutyl ketone and cyclohexanone.

9. The optical layered body according to claim 1, further comprising a low refractive index layer.

10. The optical layered body according to claim 1, further comprising an antifouling layer.

11. A method of producing an optical layered body comprising the step of applying a hard coat layer-forming composition onto a light-transmitting substrate to form a hard coat layer,
wherein the hard coat layer-forming composition contains a quaternary ammonium salt having a weight average molecular weight of 1000 to 50000, a tri- or morefunctional (meth)acrylate compound having a weight average molecular weight of 700 or less, and a permeable solvent.

12. A method of producing an optical layered body comprising the steps of applying an antistatic layer-forming composition onto a light-transmitting substrate to form an antistatic layer, and applying a hard coat layer-forming composition onto the antistatic layer to form a hard coat layer,
wherein the hard coat layer-forming composition contains a quaternary ammonium salt having a weight average molecular weight of 1000 to 50000, a tri- or morefunctional (meth)acrylate compound having a weight average molecular weight of 700 or less, and a permeable solvent.

13. A method of producing an optical layered body comprising the steps of applying a hard coat layer-forming composition onto a light-transmitting substrate to form a hard coat layer, and applying an antistatic layer-forming composition onto the hard coat layer to form an antistatic layer,
wherein the hard coat layer-forming composition contains a quaternary ammonium salt having a weight average molecular weight of 1000 to 50000, a tri- or morefunctional (meth)acrylate compound having a weight average molecular weight of 700 or less, and a permeable solvent.

14. A polarizer comprising a polarizing element,
wherein the polarizer comprises the optical layered body according to claim 1 on the surface of the polarizing element.

15. An image display device comprising the optical layered body according to claim 1, or the polarizer according to claim 13 at the outermost surface.

16. The optical layered body according to claim 2, wherein the quaternary ammonium salt is a compound having a photoreactive unsaturated bond.

17. The optical layered body according to claim 2, wherein the hard coat layer-forming composition further contains a hexa- or morefunctional (meth)acrylate compound having a weight average molecular weight of 1000 or more.

18. The optical layered body according to claim 2, wherein the light-transmitting substrate is made from triacetyl cellulose.

19. The optical layered body according to claim 2, wherein the permeable solvent is at least one selected from the group consisting of methyl acetate, ethyl acetate, butyl acetate, methyl ethyl ketone, methyl isobutyl ketone and cyclohexanone.

20. The optical layered body according to claim 2, further comprising a low refractive index layer.
